(19) United States
(12) Patent Application Publication
(10) Pub. No.: US 2015/0103440 A1
(43) Pub. Date: Apr. 16, 2015

(54) PERPENDICULAR MAGNETIC RECORDING MEDIUM AND MAGNETIC RECORDING/REPRODUCING DEVICE

(71) Applicant: Kabushiki Kaisha Toshiba, Minato-ku (JP)

(72) Inventor: Soichi OIKAWA, Hachioji-shi (JP)

(73) Assignee: Kabushiki Kaisha Toshiba, Minato-ku (JP)

(21) Appl. No.: 14/500,261

(22) Filed: Sep. 29, 2014

Related U.S. Application Data
(63) Continuation-in-part of application No. 14/165,218, filed on Jan. 27, 2014, now abandoned.

(30) Foreign Application Priority Data
Oct. 10, 2013 (JP) 2013-212792
Jun. 30, 2014 (JP) 2014-134349

(51) Int. Cl. G11B 5/66

(52) U.S. Cl. CPC G11B 5/66
USPC 360/125.03; 428/828

(57) ABSTRACT

According to one embodiment, a perpendicular magnetic recording medium includes an underlayer in which the width of the grain boundary between crystal grains is less than 0.5 nm, and a multilayered magnetic recording layer formed in contact with the underlayer by alternately stacking at least two magnetic layers and two nonmagnetic layers, which are sequentially provided on a substrate. Each of the magnetic layers is a magnetically continuous layer. The magnetic layer includes magnetic crystal grains mainly containing Co, and a plurality of pinning sites made of an oxide dispersed in the entire magnetic layer. The perpendicular magnetic recording medium has a magnetic characteristic having a magnetization curve with a slope α of 5 or more near the coercive force.

### CROSS-REFERENCE TO RELATED APPLICATIONS

This application is a Continuation-in-Part Application of U.S. patent application Ser. No. 14/165,218, filed Jan. 27, 2014 and based upon and claiming the benefit of priority from Japanese Patent Applications No. 2013-212792, filed Oct. 10, 2013; and No. 2014-134349, filed Jun. 30, 2014, the entire contents of all of which are incorporated herein by reference.

### FIELD

Embodiments described herein relate generally to a perpendicular magnetic recording medium and a magnetic recording/reproducing device.

### BACKGROUND

Currently, the medium of an HDD uses a CoCrPt-oxide granular type magnetic recording layer. To increase the areal recording density, the CoCrPt magnetic grains need to be small. However, when the magnetic grains are small, the thermal stability decreases, and data is readily lost. The thermal stability can be improved by increasing the perpendicular magnetic anisotropy. However, the coercive force at the time of high-speed magnetization reversal also increases. If the coercive force becomes greater than the recording magnetic field of the head, sufficient recording is impossible. A bit-patterned medium (BPM) has been examined as a solution. However, since the flatness of the medium surface deteriorates when processing the magnetic recording layer, the head readily comes into contact with the medium. For this reason, a medium formed without surface processing can be used. Additionally, in the BPM, the servo and data bit positions are determined at the time of processing. However, they can be freely set after completion of the medium.

For these reasons, a percolated perpendicular medium (PPM) has been proposed. The PPM has pores or nonmagnetic pinning sites in a magnetic layer of a domain wall displacement type to pin the domain wall, thereby maintaining a bit. Since one bit surrounded by a domain wall serves as a unit of thermal stability, which is larger than one grain, the thermal stability of the PPM is higher than that of granular media. In addition, since the coercive force is decreased by domain wall displacement, easy recording can be expected. However, for example, a CoCrPt-oxide-based PPM has problems of poor perpendicular magnetic anisotropy and heat treatment on a previous experimental report. A Co/Pt-pore type PPM has a problem of surface roughness because the substrate is processed.

### BRIEF DESCRIPTION OF THE DRAWINGS

The patent or application file contains at least one photograph executed in color. Copies of this patent or patent application publication with color photograph(s) will be provided by the Office upon request and payment of the necessary fee.

FIG. 1 is a schematic sectional view showing an example of a perpendicular magnetic recording medium according to the first embodiment;

FIG. 2 is a schematic sectional view showing another example of a perpendicular magnetic recording medium according to the second embodiment;

FIG. 3 is a plan view schematically showing the structure of a multilayered perpendicular magnetic recording layer shown in FIG. 1;

FIG. 4 is a partially exploded perspective view showing an example of a magnetic recording/reproducing device according to the embodiment;

FIG. 5 is a photograph showing a planar TEM image of an underlayer used in the embodiment;

FIG. 6 is a photograph showing a DF-STEM image of the sectional structure of an example of the magnetic recording medium according to the embodiment;

FIG. 7 is a graph showing the magnetization curve of the magnetic recording medium according to the embodiment;

FIG. 8 is a graph showing the relationship between the oxide content and the magnetic characteristic of an example of the magnetic recording medium according to the embodiment;

FIG. 9 is a photograph showing a DF-STEM image of the sectional structure of another example of the magnetic recording medium according to the embodiment;

FIG. 10 is a photograph showing a DF-STEM image of the planar structure of the multilayered magnetic recording layer of the magnetic recording medium according to the embodiment;

FIG. 11 is a graph showing the relationship between the oxide content and the magnetic characteristic of another example of the magnetic recording medium according to the embodiment;

FIG. 12 is a graph showing the magnetization curve of a comparative magnetic recording medium;

FIG. 13 is a graph showing the relationship between the oxide content and the magnetic characteristic of still another example of the magnetic recording medium according to the embodiment;

FIG. 14 is a graph showing the relationship between the oxide content and the magnetic characteristic of still another example of the magnetic recording medium according to the embodiment;

FIG. 15 is a graph showing the relationship between the oxide content and the magnetic characteristic of still another example of the magnetic recording medium according to the embodiment;

FIG. 16 is a view showing a micromagnetics simulation calculation model viewed from the upper side, which is an example of the perpendicular magnetic recording medium according to the embodiment;

FIG. 17 is a photograph showing an image of an example of a micromagnetics simulation calculation model in the in-plane direction of an example of the perpendicular magnetic recording medium according to the first embodiment;

FIG. 18 is a photograph showing an image of an example of a micromagnetics simulation calculation model in the in-plane direction of another example of the perpendicular magnetic recording medium according to the first embodiment;

FIG. 19 is a perspective view showing a micromagnetics simulation calculation model of an example of the perpendicular magnetic recording medium according to the second embodiment;

FIG. 20 is a photograph showing an image of an example of a micromagnetics simulation calculation model in the in-plane direction of an example of the perpendicular magnetic recording medium according to the second embodiment;

FIG. 21 is a photograph showing an image of an example of a micromagnetics simulation calculation model in the in-plane direction of an example of the perpendicular magnetic recording medium according to the second embodiment;

FIG. 22 is a graph showing the relationship between the oxide content and the magnetic characteristic of still another example of the magnetic recording medium according to the embodiment;

FIG. 23 is a graph showing the relationship between the oxide content and the magnetic characteristic of still another example of the magnetic recording medium according to the embodiment;

FIG. 24 is a graph showing the relationship between the oxide content and the magnetic characteristic of still another example of the magnetic recording medium according to the embodiment;

FIG. 25 is a graph showing the relationship between the oxide content and the magnetic characteristic of still another example of the magnetic recording medium according to the embodiment;

FIG. 26 is a graph showing the relationship between the oxide content and the magnetic characteristic of still another example of the magnetic recording medium according to the embodiment;

FIG. 27 is a graph showing the relationship between the oxide content and the magnetic characteristic of still another example of the magnetic recording medium according to the embodiment;

FIG. 28 is a graph showing the relationship between the oxide content and the magnetic characteristic of still another example of the magnetic recording medium according to the embodiment; and

FIG. 29 is a graph showing the relationship between the oxide content and the magnetic characteristic of still another example of the magnetic recording medium according to the embodiment.

### DETAILED DESCRIPTION

In general, according to one embodiment, there is provided a perpendicular magnetic recording medium including a substrate, an underlayer provided on the substrate, and a multilayered magnetic recording layer provided in contact with the underlayer, including at least two magnetic layers and two nonmagnetic layers which are alternately stacked.

The underlayer is made of crystal grains, and the width of the grain boundary between the crystal grains is less than 0.5 nm. Each of the magnetic layers and the nonmagnetic layers of the multilayered magnetic recording layer is a continuous layer. The magnetic layer is made of magnetic crystal grains mainly containing Co and an oxide dispersed in the entire magnetic layer, and includes a plurality of pinning sites capable of pinning a domain wall. The perpendicular magnetic recording medium has a magnetic characteristic representing that the slope α of a magnetization curve near the coercive force is 5 or more.

Note that the main component indicates a component, for example, an element, a compound, or the like contained in a largest amount in the material of an object.

According to the embodiment, there is provided a magnetic recording/reproducing device including the perpendicular magnetic recording medium and a magnetic head.

According to the embodiment, it is possible to simultaneously achieve a high thermal stability and recording easiness and obtain a high areal recording density by using a multilayered film including pinning sites as the magnetic recording layer of the perpendicular magnetic recording medium.

In the perpendicular magnetic recording medium according to the embodiment, pinning sites that do not form a solid solution with a magnetic metal can be buried using a superlattice capable of obtaining a high perpendicular magnetic anisotropy as a base.

According to the embodiment, even when an oxide that readily segregates in the grain boundary is used as a pinning site, a structure in which the magnetic grains are surrounded by oxide boundary and magnetically isolated is not formed. Instead, the thickness of the grain boundary is intentionally made nonuniform and concentrated to a specific portion, thereby causing the oxide to function as excellent pinning sites.

### <Substrate>

As a substrate, for example, a glass substrate, an Al alloy substrate, a ceramic substrate, a carbon substrate, an Si single crystalline substrate having an oxidized surface, or the like is usable.

Examples of the glass substrate are amorphous glass and crystallized glass. As the amorphous glass, for example, general-purpose soda lime glass, aluminosilicate glass, or the like is usable. As the crystallized glass, for example, lithium crystallized glass is usable. As the ceramic substrate, for example, a general-purpose sintered compact mainly containing aluminum oxide, aluminum nitride, silicon nitride, or the like or a fiber reinforced material thereof is usable.

Alternatively, a structure obtained by forming an NiP layer on the surface of the above-described metal or nonmetal substrate using plating or sputtering may be used as the substrate.

Although only sputtering has been exemplified as a method of forming a thin film on a substrate, the same effect can also be obtained using vacuum deposition or electroplating.

### <Soft Magnetic Underlayer>

In the embodiment, when a soft magnetic underlayer having a high magnetic permeability is provided between the substrate and the perpendicular magnetic recording layer, a so-called double-layered perpendicular medium can be formed. In this double-layered perpendicular medium, the soft magnetic underlayer takes on part of the function of the magnetic head that horizontally flows a recording magnetic field from the magnetic head, for example, a single-pole magnetic head configured to magnetize the perpendicular magnetic recording layer and returns the field to the magnetic head side. The soft magnetic underlayer can serve to apply a steep and sufficient vertical magnetic field to the magnetic recording layer and improve the recording/reproducing efficiency.

A material containing, for example, Fe, Ni, and Co can be used in the soft magnetic underlayer. Examples of the material are an FeCo alloy such as FeCo or FeCoV, an FeNi alloy such as FeNi, FeNiMo, FeNiCr, or FeNiSi, an FeAl alloy or FeSi alloy such as FeAl, FeAlSi, FeAlSiCr, FeAlSiTiRu, or FeAlO, an FeTa alloy such as FeTa, FeTaC, or FeTaN, and an FeZr alloy such as FeZrN.

Alternatively, a material having a crystallite structure of FeAlO, FeMgO, FeTaN, FeZrN, or the like containing 60 at % or more of Fe or a granular structure formed by dispersing fine crystal grains in a matrix can be used.

As another material of the soft magnetic underlayer, a Co alloy containing Co and at least one of Zr, Hf, Nb, Ta, Ti, and Y is usable. Co can be contained at 80 at % or more. Such a Co alloy readily forms an amorphous layer at the time of film formation by sputtering. An amorphous soft magnetic material has none of magnetocrystalline anisotropy, crystal defects, and grain boundary and therefore exhibits a very excellent soft magnetism.

As the amorphous soft magnetic material, an alloy containing cobalt as the main component and zirconium as the accessory component, for example, a CoZr alloy such as CoZr, CoZrNb, or CoZrTa is usable. B can further be added to the above-described materials for the purpose of, for example, easily forming an amorphous material.

A soft magnetic underlayer made of an amorphous material hardly directly affects the crystal orientation of a metal layer formed on it, like an amorphous substrate. For this reason, even when the material is changed, the structure or crystallinity of the magnetic recording layer does not largely change, and the same magnetic characteristic and magnetic recording/reproduction characteristic can basically be expected. If only the third element changes as in a CoZr alloy, changes in the saturation magnetization (Ms), coercive force (Hc), magnetic permeability (μ), and the like are also small. Hence, almost the same magnetic characteristic and magnetic recording/reproduction characteristic can be obtained.

### <Underlayer>

In the perpendicular magnetic recording medium according to the embodiment, an underlayer can be provided between the perpendicular magnetic recording layer and the substrate or the soft magnetic underlayer provided on the substrate.

As the underlayer, for example, Ru, Rh, Pd, Pt, or Ti, which is a metal having an hcp or fcc structure, is usable. These materials have a close-packed crystal structure, like Co, Pt, or Pd that is the main component of the recording layer. The lattice mismatching is not too large. The close-packed plane readily grows parallel to the film plane. Hence, the layer tends to easily grow into a columnar shape. An alloy containing at least one material selected from the group consisting of Ru, Rh, Pd, Pt, and Ti and at least one material selected from the group consisting of Co and Cr can also be used. In addition, at least one material selected from the group consisting of B, Ta, Mo, Nb, Hf, Ir, Cu, Nd, Zr, W, and Nd can be added.

In a conventional granular medium in which magnetic grains in the magnetic recording layer are magnetically isolated, the crystal grains in the underlayer are also structurally separated. Especially when a Ru underlayer formed in a high gas pressure is used, a CoPtCr-oxide granular type magnetic layer in which the magnetic grains are surrounded by a relatively uniform grain boundary layer of about 1 nm or more can be formed. When a PPM is formed using an oxide, the oxide tends to segregate around the magnetic crystal grains. However, the grains can be not magnetically isolated. The grain boundary layer rather has an nonuniform thickness and partially magnetically couples with adjacent grains because of its thinness. On the other hand, the oxide concentrates to form large lumps between the grains, which can function as domain wall pinning sites. Hence, in the PPM, it may be possible to form an underlayer in a low gas pressure not to form gaps between the crystal grains in the underlayer or to narrow the grain boundary width in the underlayer. Although it depends on the film forming apparatus, the appropriate gas pressure when forming the underlayer can be, for example, 0.05 to 3 Pa. When the gas pressure is less than 0.05 Pa, discharge tends to hardly occur, and sputtering tends to be difficult. When the gas pressure exceeds 3 Pa, gaps tend to form between the grains in the underlayer, and the magnetic grains tend to be readily isolated. The gas pressure can be 0.1 to 1.5 Pa. The grain boundary can have no substantial thickness, and the grain boundary width can be less than 0.5 nm at the most. The nearest-neighbor atom distance of a transition metal normally used for sputtering is 0.25 to 0.3 nm. In the crystal grains, the lattice is formed at this spacing. In a polycrystalline film, the grain boundary is a defect of crystal grains. Hence, the interatomic distance in the grain boundary is greater than the nearest-neighbor atom distance. If the interatomic distance is less than 0.5 nm or double the nearest-neighbor distance, the crystal grains can be regarded to have almost no gaps between them.

In addition, the perpendicular magnetic recording medium can improve the crystal grain size or crystal orientation of the magnetic recording layer by stacking a plurality of underlayers. If the underlayer can be made thin by these improvements, the recording/reproduction characteristic can also be improved by shortening the distance (spacing) between the magnetic head and the soft magnetic underlayer. When the underlayer on the side close to the soft magnetic underlayer can have a soft magnetic characteristic, it can function as a underlayer and further shorten the distance to the magnetic head.

As the material of the underlayer according to the embodiment, an hcp or fcc metal is advantageous because it easily improves the crystal orientation. However, a bcc metal can be used for the underlayer on the side not in contact with the perpendicular magnetic recording layer. With this metal, the effect of reducing the crystal grain size of the underlayer because of the difference in the crystal structure can be expected. Stacking a plurality of materials is not essential. However, when doing this, a material can contain at least one material selected from the group consisting of, for example, Ru, Pd, Pt, Cu, Ni, W, Ta, Ti, Al, and an alloy thereof. To improve the characteristic, these materials may be mixed, another element may be mixed, or the materials may be stacked.

Especially when using Ru as the material of the underlayer, Ti/Cu or AlSi/Pd has been reported as a seed layer stacked under Ru to reduce the crystal grain size. Assume a case in which, for example, one magnetic grain grows on one Ru crystal grain of the underlayer in a conventional CoPtCr granular medium containing an oxide. In this case, if the magnetic grains are made small by decreasing the grain size of Ru, the grain size variance tends to be large, or the grain boundary layer thickness tends to be nonuniform. As described above, in the PPM that uses an oxide as pinning sites, this tendency can be acceotable. In the PPM according to the embodiment, the magnetic recording layer is assumed to be a Co-based multilayered film. The material is similar to that of a conventional CoPtCr recording layer. For this reason, when an Ru underlayer is used, the grains of the multilayered film are thought to readily grow in a one-to-one correspondence with the Ru grains. In this case, control of the grain size of the recording layer by the grain size of the underlayer is also easy. Even when the grain size and its variance change due to the seed layer, reduction of the grain size of the underlayer is acceptable in the PPM using an oxide. When Pt or Pd is used for the nonmagnetic layer of the multilayered film, Pt or Pd is better than Ru as the material of the underlayer from the viewpoint of lattice matching if the grain size can be reduced.

The thickness of the underlayer can be 0.1 to 50 nm, and further, 4 to 30 nm. In general, the underlayer, which is not necessarily made of Ru, can be thick because the crystallinity can readily be raised. However, the effect of improving the crystal grain size or crystal orientation may be expected even when the average thickness is less than or equal to one atomic layer, and an island-dotted structure is formed. However, if the thickness is less than 0.1 nm, improving the magnetic layer structure tends to be difficult. If the underlayer is made of a soft magnetic material that exhibits an excellent characteristic, there is no limitation on the maximum value from the viewpoint of spacing. Normally, however, when the underlayer has an excessive thickness more than 50 nm and has no magnetism, the recording capability of the magnetic head or the recording resolving power tends to be decrease because of an increase in the spacing.

### <Perpendicular Magnetic Recording Layer>

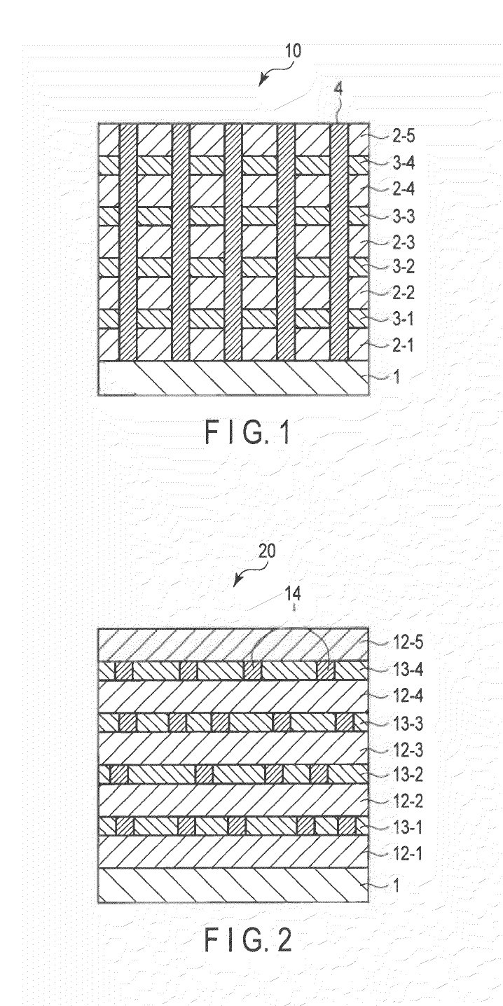

FIG. 1 is a schematic sectional view showing an example of the perpendicular magnetic recording medium according to the embodiment.

FIG. 2 is a schematic sectional view showing another example of the perpendicular magnetic recording medium according to the embodiment.

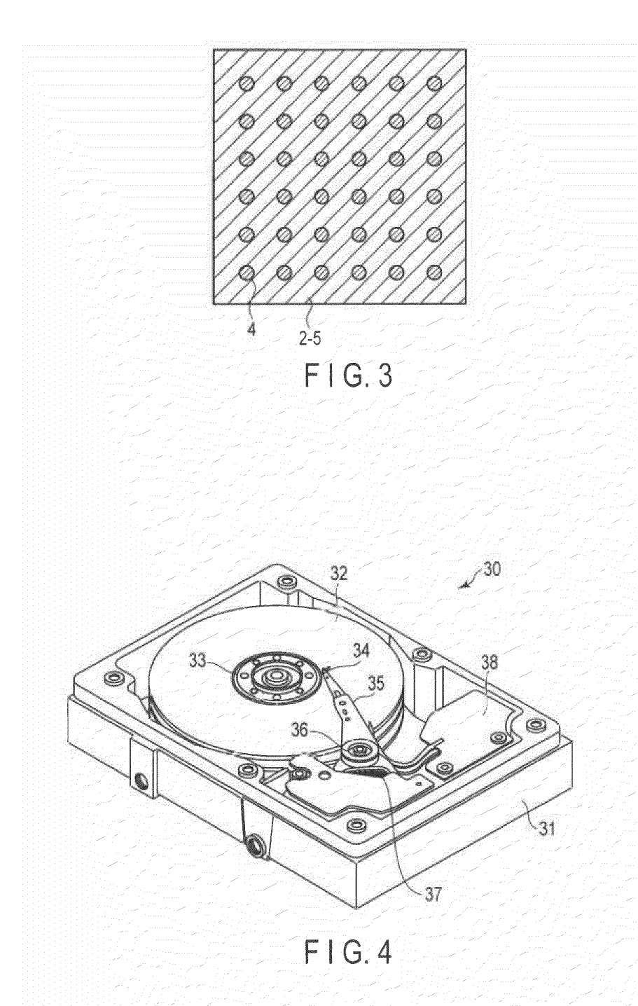

FIG. 3 is a plan view schematically showing the structure of a multilayered perpendicular magnetic recording layer shown in FIG. 1.

As shown in FIG. 1, a perpendicular magnetic recording layer 10 according to an embodiment has a multilayer structure in which nonmagnetic layers 2-1, 2-2, 2-3, 2-4, and 2-5 and magnetic layers 3-1, 3-2, 3-3, and 3-4 are alternately stacked on a substrate 1. The magnetic layers 3-1, 3-2, 3-3, and 3-4 include a plurality of pinning sites that are dispersed in the magnetic material portions and made of a nonmagnetic metal different from the nonmagnetic material as the main component of the nonmagnetic layers. The nonmagnetic layers 2-1, 2-2, 2-3, 2-4, and 2-5 include a plurality of pinning sites that are dispersed in the nonmagnetic material portions and made of a nonmagnetic metal different from the nonmagnetic material. The pinning sites in the nonmagnetic layers are coupled with those in the adjacent magnetic layers to form columnar pinning sites 4. Note that in FIG. 1, the columnar pinning sites schematically extend through the multilayered magnetic recording layer in a direction perpendicular to the film plane. However, the pinning sites may be bent or discontinuous.

As shown in FIG. 2, a perpendicular magnetic recording medium 20 according to another embodiment has a multilayer structure in which nonmagnetic layers 12-1, 12-2, 12-3, 12-4, and 12-5 and magnetic layers 13-1, 13-2, 13-3, and 13-4 are alternately stacked on a substrate 1. The magnetic layers 13-1, 13-2, 13-3, and 13-4 include a plurality of pinning sites 14 that are dispersed in the magnetic material portions and made of a nonmagnetic metal different from the nonmagnetic material as the main component of the nonmagnetic layers. The pinning sites 14 are dotted and scattered in the film planes of the magnetic layers 13-1, 13-2, 13-3, and 13-4.

In a medium in which the magnetic layers are strongly coupled in the film plane, and magnetization reversal is caused by domain wall displacement, the above-described nonmagnetic regions act as pinning sites that suppress domain wall displacement. When the pinning sites are columnar, as shown in FIG. 1, a greater domain wall pinning effect can be expected. When the pinning sites are dotted, as shown in FIG. 2, the film plane includes the pinning sites everywhere when several magnetic layers are stacked and viewed from the upper side. This structure is supposed to be used for high-density recording because the domain wall stop position, that is, the boundary between recording bits can be determined relatively freely. The pinning sites can be periodically arranged as shown in FIG. 3. However, the periodical arrangement is difficult in the normal sputtering process. Hence, the pinning sites may be arranged at random, as shown in FIG. 2.

Note that if the thickness of the domain wall is greater than the diameter of the pinning site, the domain wall tends not to be pinned. The domain wall thickness needs to be less than the pinning site diameter because the result is obtained even by calculations using micromagnetics simulations.

For example, when the areal recording density is about 3 Tbits/inch², the bit length in the head traveling direction is about 10 nm (although it depends on the track width). For this reason, it is expected that the thickness of the domain wall serving as the transition region between the bits needs to be 5 nm or less.

A thickness δ of the domain wall is given using an exchange stiffness constant A and a magnetic anisotropy constant K by

δ=π\sqrt{(A/K)} (1)

Hence, for example, to obtain a domain wall thickness of 5 nm when the exchange coupling is strong (A=1 μerg/cm), a considerably high magnetic anisotropy K=4×10⁷ erg/cc is necessary. When the areal recording density is low, or A is small, the value of required K can be made small. In this case, however, K can be, for example, 1×10⁷ erg/cc or more.

The pinning site diameter depends on Ku (uniaxial magnetocrystalline anisotropy constant: perpendicular magnetic anisotropy when the crystal axis is directed in the direction perpendicular to the film plane). However, a greater pinning site diameter can increase the pinning energy and raise thermal stability. On the other hand, when the recording density rises, one bit becomes small, and therefore, the pinning site diameter also needs to be smaller. The pinning site diameter can be, for example, 1 to 10 nm. The pinning strength depends on the domain wall thickness. If the areal recording density is 1 Tbit/inch² or more, the pinning site diameter can be 2 to 6 nm. The packing density of the pinning sites can be roughly, for example, 10% to 50%, and further, 20% to 40%, although depending on the pinning site diameter or the required areal recording density.

### (Materials)

The material of the magnetic layer in the multilayered magnetic recording layer mainly contains Co capable of obtaining a high Ku. Co has an advantage of a high corrosion resistance as compared to Fe or rare earth elements. Assume that Pt or Pd is used as the material of the nonmagnetic layer in the Co-based multilayered film. In this case, normally, an especially high Ku of 1×10⁷ erg/cc or more is obtained when the close-packed plane is oriented in a crystalline substance. Since a thin domain wall, hence, a narrow inter-bit transition region can be obtained, a high areal recording density can be expected. Ni may be used in the nonmagnetic region, although it is a magnetic material. The Ku of a [Co/Ni] multilayered film is less than in a case in which Pt or Pd is used. However, a high thermal stability obtained when the layers are magnetically coupled or an increase in the reproduction output caused by the magnetic material can be expected. Any other material is also usable if a high Ku can be obtained by a multilayer structure.

The material of the nonmagnetic pinning sites must not mix with the magnetic layers. When a metal such as Co is used as the magnetic grains, an oxide is often generally selected as a material that readily separates. However, the oxide tends to segregate in grain boundaries, as in the conventional granular type magnetic layer. A common conventional technique uses the properties to form an oxide grain boundary layer that is so thick and uniform as to eliminate the exchange coupling between the magnetic grains. The PPM, however, aspires to obtain a structure in which the nonmagnetic pinning sites are dotted, as shown in FIG. 3. Hence, the oxide can concentrates to a specific point. In a system in which an alloy and an oxide are combined, a structure close to that shown in FIG. 3 can be made by intense heat treatment. In the present invention in which heating is performed only to such an extent that the multilayer structure does not break or the flatness of the medium surface does not deteriorate, however, the oxide does not concentrate to one point too much.

In this embodiment, as described in the paragraph of an underlayer, a magnetic recording layer in which the thickness of the oxide grain boundary layer is intentionally made nonuniform has been devised. When the oxide is added in a state in which the crystal grain size of the underlayer is reduced to decrease the gaps between the crystal grains, and the gaps between the crystal grains of the magnetic layers are also decreased, portions where the grain boundary layer is thin and portions where the expelled oxide concentrates are formed in the magnetic layers. At the portions where the grain boundary layer is thin, the exchange coupling between the grains is not eliminated. In such a structure in which the whole film is magnetically connected somewhere, a domain wall is formed, and magnetization reversal is caused by domain wall displacement. On the other hand, the portions where the oxide concentrates act to suppress the domain wall displacement. On the magnetization curve, the coercive force Hc increases. At the time of recording by the head, the domain wall is pinned to enable high-density recording. The gaps may partially be absent between the grains. However, if a grain boundary layer exists, albeit thin, it is surmised that A of equation (1) becomes small, and the domain wall becomes thin in the grain boundary layer and is readily pinned at the grain boundary. From the experience of the conventional granular medium, the exchange coupling is considered to be almost eliminated when the grain boundary layer thickness is 1 nm or more at a portion where adjacent magnetic grains are closest. For this reason, the width of the grain boundary between adjacent magnetic crystal grains according to this embodiment can be 0 to 1 nm (exclusive) at a portion where the crystal grains are closest at the most or 1 nm or more at a portion where the crystal grains are apart farthest from each other. The maximum value at the portion where the crystal grains are apart farthest should be almost equal to the above-described pinning site diameter.

As for the magnetic crystal grains, in the structure in which the pinning sites are arranged at random, as shown in FIG. 2, the boundary between the recording bits is relatively independent of the grain shape, as described above. For this reason, the restriction on the grain size is small. In contrast, when columnar pinning sites are formed, as shown in FIG. 1, the bit boundary is located on a line that connects the pinning sites or on the grain boundary layer. To increase the recording density, the grain size can be small. In this case, the magnetic grain diameter (average diameter) can depend on the areal recording density, and if the areal recording density is, for example, 1 Tbit/inch² or more, the grain diameter can be 2 to 10 nm, and further, 4 to 8 nm. When the magnetic grain diameter is less than 2 nm, it is expected that the crystallinity of the grains decreases, and the magnetic characteristic degrades. When the magnetic grain diameter exceeds 8 nm, implementation of a high areal recording density tends to be difficult.

The oxide to be added to the multilayered magnetic recording layer can contain at least one substance selected from the group consisting of TiO, TiO₂, and SiO₂, WO₃, Ta₂O, CoO. In particular, a Ti oxide can be used because a high coercive force Hc or a high signal-to-noise ratio can be obtained. The oxide material should have a stoichiometric composition as a target. However, once sputtered, the oxide is temporarily decomposed. In the formed film, the oxide does not necessarily have the composition of the original oxide and often exists more in the amorphous grain boundary. Co of the magnetic layers in the multilayered film is a material that readily oxidizes, and is considered to partially bond with oxygen contained in the oxide material. In this case, the Co oxide also forms part of the grain boundary and functions as pinning sites.

The multilayered magnetic recording layer can include not only the main components such as Co, Pd, Pt, and an oxide but also at least one element selected from the group consisting of Ti, Si, Cr, Al, Mo, W, Ta, Ru, Rh, Cu, Ag, and Au as an accessory component. A nonmagnetic material that does not form a solid solution with Co can be expected to function as pinning sites independently of whether it is oxidized or not. A material that forms an alloy or a compound with Co can additionally be expected to have the effect of reducing the exchange coupling of Co and thinning the domain wall in the magnetic grains. When, for example, Cr is added, it partially forms an alloy with Co and also partially oxidizes. In addition, when the above-described elements are contained, size reduction of the magnetic crystal grains can be prompted, or the crystallinity or orientation can be improved.

### (Slope α of Magnetization Curve)

In general, the thinner the magnetic layer is, the higher the obtained Ku is. However, if the magnetic layer is thinner than one atomic layer of about 0.2 nm, Ku tends to conversely decrease. Hence, the thickness can be 0.2 to 1 nm. For example, the magnetic layer can be 0.4 nm thick.

The thickness of the nonmagnetic layer can be optimized to obtain a high Ku. In a [Co/Pt] or [Co/Pd] multilayered film, the thickness of the nonmagnetic layer can be 0.2 to 2 nm, and further, 0.4 to 1.2 nm, although it depends on the material used for the perpendicular magnetic recording layer or the material of the underlayer. If the nonmagnetic layer is thinner than 0.2 nm, obtaining a high Ku tends to be difficult. If the thickness exceeds 2 nm, the head field tends not to sufficiently cross the perpendicular magnetic recording layer because the layer is too thick.

Note that in the multilayered magnetic recording layer, a large interface magnetic anisotropy can be obtained when the magnetic layers are sufficiently sandwiched between the nonmagnetic layers. Hence, the thickness of the magnetic layer can be less than or equal to that of the nonmagnetic layer.

The thickness of the magnetic layer or nonmagnetic layer need not always be the same from the first layer to the uppermost layer. When the thicknesses of each layer is adjusted, Ku or Ms in the film thickens direction can be changed to appropriately adjust an anisotropy magnetic field Hk (=2Ku/Ms). For example, when performing recording using the magnetic head, the recording magnetic field is large at a portion of the perpendicular magnetic recording layer close to the head. The greater the distance from the head is, the smaller the recording magnetic field is. Accordingly, Hk of the upper portion of the recording layer can be set high, and Hk of the lower portion can be set low.

The number of layers of the multilayered magnetic recording layer can be 3 to 40, and further, 5 to 20. Within this range, the device can operates as a magnetic recording/reproducing device for a higher recording density. If the number of layers of the multilayered magnetic recording layer is less than 3, the number of magnetic layers is small, the reproduction output is too low, and the system noise ratio tends to rise. If the number of layers of the multilayered magnetic recording layer exceeds 40, the reproduction output is too high, and the waveform tends to be distorted.

The coercive force Hc of the perpendicular magnetic recording layer can be 2 kOe or more. If the coercive force Hc is less than 2 kOe, pinning is insufficient, and obtaining a high areal recording density tends to be difficult.

The perpendicular squareness ratio of the perpendicular magnetic recording layer can be 0.9 or more. If the perpendicular squareness ratio is less than 0.9, the crystal orientation may be degrade, or a structure in which the thermal stability partially decreases may be formed.

The magnetic field at the intersection between the tangent of the magnetization curve near Hc and the negative saturation value is defined as a nucleation magnetic field Hn. Hn can be less than Hc but s large as possible from the viewpoint of reproduction output, thermal decay resistance, information erase resistance at the time of adjacent track recording, and the like. However, increasing Hn means making the slope α of the magnetization curve near Hc large. In the conventional granular type perpendicular magnetic recording medium, when α is made large, the signal-to-noise ratio tends to decrease undesirably.

In general, the slope α of the magnetization curve near the coercive force Hc is expressed as

α=dM/dH|H=Hc (2)

In this embodiment, α is defined using Ms (emu/cc), Hc, and Hn (Oe) of the centimeter-gram-second units system as

α=4πMs/(Hc−Hn) (3)

Note that when the magnetic recording layer has a multilayer structure formed by alternately stacking magnetic layers and nonmagnetic layers, Ms is often calculated using the volume of only the magnetic layers. In this case, however, when indicating the numerical values of Ms and α, the volume of the entire multilayered magnetic recording layer including the nonmagnetic layers is basically used in consideration of comparison with a single magnetic layer like a granular type magnetic layer.

The slope α of the magnetization curve near Hc of the perpendicular magnetic recording layer is known to be almost 1 when the exchange coupling between the magnetic grains is much less than the magnetostatic coupling. When the exchange coupling is strong, (Hc−Hn) is small and α is greater than 1. In a granular type perpendicular magnetic recording medium currently in practical use, a generally satisfactory recording/reproduction characteristic can be obtained when the coupling of grains is strong to some extent. Hence, α is set to be about 2. Basically, however, when the coupling of grains is weak, a high line recording density and a high signal-to-noise ratio tend to be obtained. In the granular type perpendicular magnetic recording medium, such a strong coupling between grains that makes a greater than 3 is undesirable. When α is 5 or more, the magnetic grains are considered to show a strong tendency of causing magnetization reversal not independently but under the influence of magnetization reversal of adjacent grains.

In a soft magnetic material that is known well to cause magnetization reversal of a domain wall displacement type, the value of Hc or Hn is small, and therefore, α has a large value of 1,000 to 10,000. In a hard magnetic material used for the magnetic recording layer, magnetization rotation readily occurs because of its large magnetic anisotropy, and the transition region corresponding to the domain wall is very thin. For these reasons, expressing the magnetization reversal as a domain wall displacement type may be not appropriate even when α is large. However, when α is 5 or more, the progress of magnetization reversal can be regarded as almost the same as the domain wall displacement type.

The magnetic recording medium according to this embodiment assumes not magnetization reversal of the magnetization rotation type of the conventional granular medium but magnetization reversal of the domain wall displacement type. Hence, the slope α of the magnetization curve near Hc is 5 or more, which can be because a large Hn can be ensured.

### <Protective Layer>

The protective layer can prevent corrosion of the perpendicular magnetic recording layer and also damage to the medium surface caused by the magnetic head in contact with the medium. The material can contain, for example, C, SiO₂, or ZrO₂.

The thickness of the protective layer can be 1 to 6 nm. This can be used for high density recording because the distance between the head and the medium can be shortened. When the thickness of the protective layer is less than 1 nm, the effect of preventing corrosion or damage to the magnetic recording layer tends to be insufficient. When the thickness exceeds 6 nm, recording/reproduction at a high density tends to be difficult because the distance between the head and the magnetic recording layer is long.

A lubricating layer (not shown) can be provided on the protective layer.

As the lubricant used for the lubricating layer, for example, perfluoropolyether, alcohol fluoride, fluorinated carboxylic acid, or the like can be used.

### <Magnetic Recording/Reproducing Device>

FIG. 4 is a partially exploded perspective view showing an example of a magnetic recording/reproducing device according to this embodiment.

As shown in FIG. 4, a perpendicular magnetic recording device 30 according to this embodiment includes a rectangular-box-shaped case 31 having an opening on the upper side, and a top cover (not shown) that is screwed to the case 31 by a plurality of screws and closes the upper opening of the case.

The case 31 stores a perpendicular magnetic recording medium 32 according to this embodiment, a spindle motor 33 serving as a driving means for supporting and rotating the perpendicular magnetic recording medium 32, a magnetic head 34 that performs recording/reproduction of a magnetic signal on the perpendicular magnetic recording medium 32, a head actuator 35 that includes a suspension with the magnetic head 34 mounted at its distal end and movably supports the magnetic head 34 with respect to the perpendicular magnetic recording medium 32, a rotating shaft 36 that rotatably supports the head actuator 35, a voice coil motor 37 that rotates and positions the head actuator 35 via the rotating shaft 36, and a head amplifier circuit 38.

The magnetic head 34 is a so-called compound head formed on an almost rectangular slider (not shown), and includes a write head having a single-pole structure, a read head using a GMR film or TMR film, and an MR (magnetoresistive) head for recording/reproduction.

In a perpendicular magnetization film of a domain wall displacement type, the coercive force is minimized when a magnetic field is applied in the vertical direction. The greater the angle made by the vertical direction and the applied magnetic field is, the greater the magnetic field necessary for the magnetization reversal is. For this reason, a write head having a single-pole structure capable of easily applying a magnetic field in the vertical direction can be used because recording is facilitated.

### EXAMPLES

### Example 1

As a nonmagnetic substrate, a cleaned disk-shaped glass substrate (available from Ohara, outer diameter: 2.5 inches) was prepared. This glass substrate was stored in the film formation chamber of a magnetron sputtering apparatus (C-3010 available from Canon Anelva). After the film formation chamber was evacuated to an ultimate pressure of 4×10−5 Pa or less, DC magnetron sputtering was performed in the following way in an Ar atmosphere at a gas pressure of about 0.6 Pa unless otherwise specified.

First, an NiTa alloy layer having a thickness of 10 nm was formed on the nonmagnetic substrate in place of a soft magnetic underlayer.

A Ti layer having a thickness of 8 nm, Cu equivalent to a thickness of 1 nm, and an Ru layer having a thickness of 10 nm and serving as an underlayer were sequentially stacked on the NiTa layer. Cu has an island-dotted structure on the Ti layer and contributes to size reduction of grains in the Ru layer.

### (Planar Structure of Underlayer)

The structure of the Ru layer will be described here. For easy analysis, a sample was prepared by setting the thickness of the Ru layer to 20 nm and forming a C protective layer without forming a magnetic recording layer. Planar TEM analysis was conducted on this sample.

FIG. 5 shows a planar TEM image obtained by removing the layers under the Ru layer and observing only the Ru layer.

The crystal grain diameter is about 10 nm. Since the film formation was done at a low gas pressure, gaps are almost absent between the grains, and the grain boundary substantially has no thickness, as can be seen. Grain boundaries that look like white or black lines exist between the crystal grains. Under magnification, boundaries where the crystal lattice does not match are formed in a zigzag pattern. Apparently, there is no portion where gaps greater than or equal to twice the lattice spacing, that is, 0.5 nm or more concentrate. A sectional STEM image including a magnetic recording layer will be shown later. At least within a thickness range of 10 to 20 nm, the grains grow columnar, and no obvious change is observed in the grain structure.

After the Ru underlayer was formed to 10 nm, the Ar gas pressure was raised to 3 Pa, and a multilayered magnetic recording layer was formed in accordance with the following procedure.

First, a Pt nonmagnetic layer having a thickness of 0.8 nm was formed. Next, a magnetic layer was formed by simultaneously sputtering Co equivalent to a thickness of 0.4 nm and TiO₂ equivalent to a thickness of 0.17 nm. At this time, the design value of the composition of the magnetic layer is Co—30 vol % TiO₂.

After the above-described procedure was repeated 12 times, a Pd layer having a thickness of 2 nm was further stacked on the final magnetic layer, thereby forming a multilayered magnetic recording layer. The thus obtained multilayered magnetic recording layer will be expressed as [Pt/Co—30 vol % TiO₂]*12 here.

Subsequently, a C protective layer having a thickness of 6 nm was stacked on the multilayered magnetic recording layer. In the obtained perpendicular magnetic recording medium, substrate/NiTa/Ti/Cu/Ru/[Pt/Co—30 vol % TiO₂]*12/Pd/C are stacked in this order.

After the protective layer was stacked in the above-described way, the structure was extracted from the film formation chamber. A lubricating layer made of perfluoropolyether and having a thickness of 1.5 nm was formed on the protective layer, thereby obtaining a perpendicular magnetic recording medium. The obtained perpendicular magnetic recording medium has the same structure as in FIG. 2 except that the lubricating layer is not illustrated.

### (Sectional Structure of Medium)

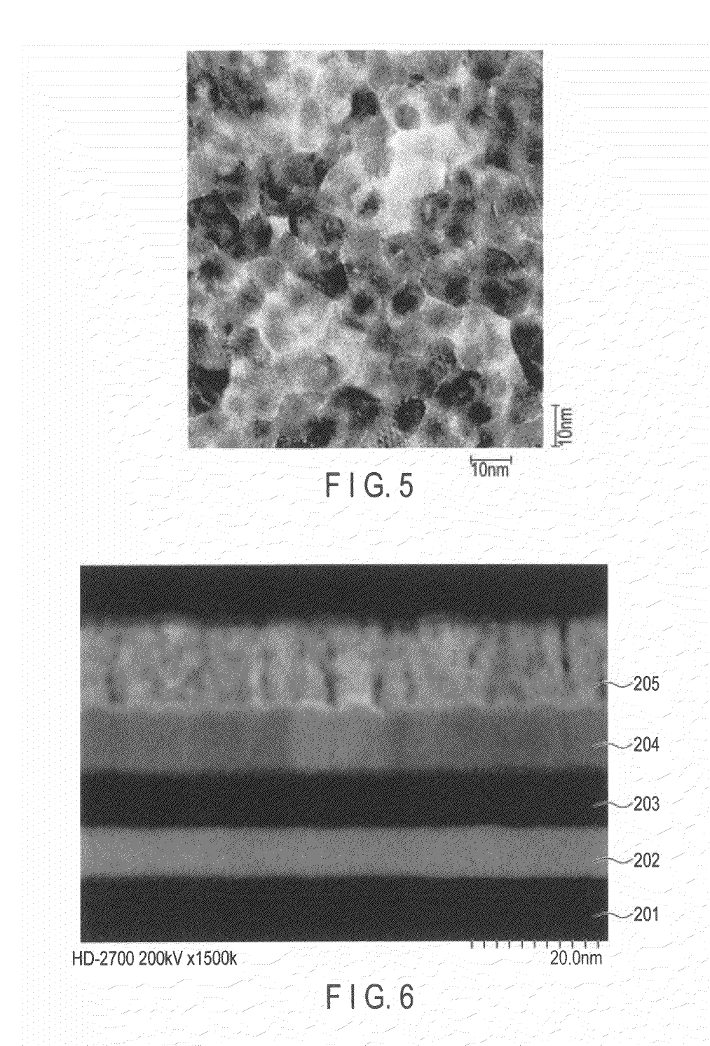

As for the sectional structure of the medium according to Example 1, FIG. 6 shows a dark field image (DF-STEM image) obtained by a scanning transmission electron microscopy.

As shown in FIG. 6, the stack of substrate 201/NiTa 202/Ti 203/Cu/Ru 204/[Pt/Co—30 vol % TiO₂]*12 205 can be identified. The stack of Pd/C on [Pt/Co—30 vol % TiO₂]*12 is difficult to identify.

In the DF-STEM image, atoms whose average atomic number is small look dark. The atoms look whitish as the atomic number becomes large. Regions that look dark and are discontinuously dotted in the multilayered magnetic recording layer are made of an oxide containing a large amount of O. As is apparent, a multilayer structure of Co that looks gray and Pt that looks whitish is formed. Roughness is observed on the surface of the Ru underlayer. Basically, portions that form valleys are grain boundaries. The Co/Pt crystal grains in the multilayered magnetic recording layer grow in the film thickens direction. The oxide appears to readily enter the position of the Ru grain boundary. The sectional image also shows overlap in the thickness direction (depth direction in FIG. 6) of the analysis sample. For this reason, although many oxide regions appear to have an in-plane direction width less than 1 nm and exhibit indistinct blackness, regions having a width of 1 nm or more can also be observed. Co and Pt are of a complete solid solution type. Hence, both Pt on the Co layer and Co on the Pt layer readily grow to cover the surface without forming islands. Even in a layer structure in which Co and Pt diffuse in each other, and compositional modulation occurs, Co and Pt are assumed to form a continuous layer in the film plane.

### (Magnetic Characteristic)

The magnetic characteristic of the obtained perpendicular magnetic recording medium was measured using a polar Kerr effect evaluation apparatus (available from NEOARK), a VSM (Vibrating Sample Magnetometer; available from Riken Densi), and a torque magnetometer (available from Toei Industry).

The polar Kerr effect evaluation apparatus can measure the magnetization curve of the magnetic recording layer on the surface side of the perpendicular magnetic recording medium (including the soft magnetic underlayer) but not the saturation magnetization Ms. When a soft magnetic underlayer is included, the VSM or the torque magnetometer measures its magnetization curve and that of the perpendicular magnetic recording layer together. It is difficult to skillfully separate and evaluate the magnetization curves. For this reason, when measuring Ku or the like using the VSM or the torque magnetometer, a sample is used in which the soft magnetic underlayer is not formed, and instead, a NiTa layer that has almost no magnetism and can obtain almost the same magnetization curve as that of the soft magnetic underlayer is formed.

All magnetization curves indicate measurement results in the direction perpendicular to the film surface, and the standard sweep time when measuring the major loop was set to 45 sec in the polar Kerr effect evaluation apparatus or 3 min in the VSM, unless otherwise specified.

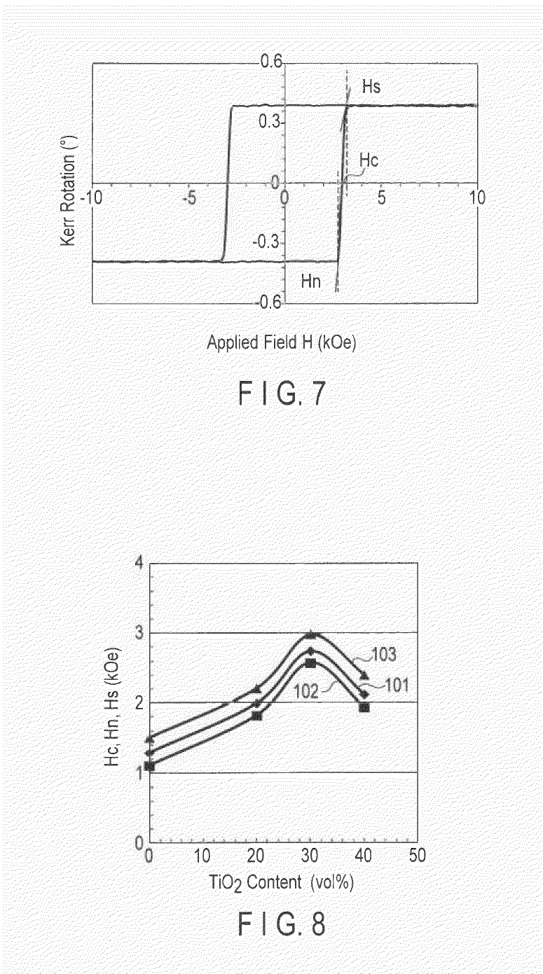

FIG. 7 shows the magnetization curve measured by the polar Kerr effect evaluation apparatus on the medium of Example 1.

The coercive force Hc indicates the intersection between the loop and the abscissa. The nucleation magnetic field Hn is the magnetic field at the intersection between the tangent in Hc and the negative saturation value. A saturation magnetic field Hs indicates the intersection between the positive saturation value and the approximate line of the region 90% to 95% of the saturation value. In the medium of Example 1, Hc=3.0 kOe, Hn=2.8 kOe, and Hs=3.3 kOe. In the conventional granular type medium, when Hc=3.0 kOe, Hn 1 kOe, and Hs 5 kOe. The magnetic head cannot perform saturation recording without outputting a recording magnetic field greater than Hs. In the PPM, since Hs can be made much less than Hc, the recording easiness can be improved.

At this time, Ms is 410 emu/cc, and the slope α of the magnetization curve in Hc is about 26. The magnetic coupling in the film plane direction of the recording layer is very strong, and magnetization reversal is caused by domain wall displacement, as is apparent. The sectional STEM image of FIG. 6 shows portions where gaps are formed between the grains. However, the grains are not magnetically isolated and are magnetically coupled at some portion in the film plane direction.

### (Recording/Reproduction Characteristic)

The recording/reproduction characteristic was evaluated using a spin stand RH4160E available from Hitachi High-Technologies. To record/reproduce information, a compound head for perpendicular recording including a single-pole recording element having an auxiliary pole tip close to the main pole and a tunnel magnetoresistive effect (TMR) reproduction element was used. Note that for the PPM, the gap between the main pole and auxiliary pole can be as wide as, for example, 100 nm or more. As the material of the recording pole, CoFeNi was used. However, a material such as CoFe, CoFeN, NbFeNi, FeTaZr, or FeTaN may be used. An additional element may be added to the magnetic material used as the main component.

In the head, the track-direction width of the main pole of the recording element and that of the reproduction element were about 300 nm and about 90 nm, respectively. The reproduction signal output/noise ratio (to be referred to as signal-to-noise ratio hereinafter) when performing recording at a linear density of 220 kFCI (a recording density at which the magnetic flux changes 220,000 times per inch) in the circumferential direction at a radial position of 22 nm and a rotational speed of 5,400 rpm was measured. An excellent value of 18.1 dB was obtained as the signal-to-noise ratio of the medium of Example 1.

### Example 2

A perpendicular magnetic recording medium was formed under the same conditions as in Example 1 except that the Ru layer thickness was set to 20 nm, the Ar gas pressure for the multilayered magnetic recording layer was set to 2 Pa, Cr was added to the Co layer to form Co—10 at % Cr, the number of layers was set to 8, and the content of TiO₂ was changed.

FIG. 8 is a graph showing the relationship between the TiO₂ content, the coercive force Hc, the nucleation magnetic field Hn, and the saturation magnetic field Hs.

In FIG. 8, 101 indicates the coercive force Hc, 102 indicates the nucleation magnetic field Hn, and 103 indicates the saturation magnetic field Hs.

As for the change in the Ru layer thickness, the change in the Ar gas pressure, Cr addition, and the change in the number of layers, the increase/decrease with respect to the addition of TiO₂ does not exhibit a large change, and the same effect as in Example 1 can be obtained, although the absolute value of the coercive force Hc and the like change.

As can be seen from FIG. 8, Hc, Hn, and Hs increase similarly along with an increase in the TiO₂ content in the Co layer, and are about two or more times at 30 vol % as large as those at 0 vol %. At this time, the differences between Hc, Hn, and Hs hardly change. This indicates that the slope of the magnetization curve in Hc maintains a large value, and magnetization reversal remains the same as that of the wall displacement type. The Hc increase in the domain wall displacement type indicates that the domain wall displacement is suppressed by adding TiO₂. It is believed that the oxide regions formed in the multilayered magnetic recording layer function as pinning sites. Note that when the TiO₂ content was 0 and 30 vol %, the slope α of the magnetization curve in Hc was 26 and 23, respectively.

The recording/reproduction characteristic was evaluated as in Example 1. When the TiO₂ content was 0 and 30 vol %, the signal-to-noise ratio was −17.8 dB and 16.8 dB, respectively. When the TiO₂ content was 0 vol %, the signal-to-noise ratio had a negative value. This is so probably because the reproduction signal output was almost zero, and recording failed, or even if not, the magnetic domain could not be held and disappeared. As is apparent from this, the effect of TiO₂ addition to the Co layer is very large, and an excellent recording/reproduction characteristic can be obtained by pinning of the domain wall.

### Example 3

First, a CoTaZr alloy layer having a thickness of 20 nm, a Ru layer having a thickness of 0.8 nm, and a CoTaZr alloy layer having a thickness of 20 nm were sequentially formed on a nonmagnetic substrate as a soft magnetic underlayer. Note that the two CoTaZr layers are anti-ferromagnetically coupled via the Ru layer provided between them. A Ti layer having a thickness of 8 nm, Cu equivalent to a thickness of 1 nm, and an Ru layer having a thickness of 20 nm and serving as an underlayer were sequentially formed on the CoTaZr layer without changing an Ar gas pressure of 0.6 Pa. Cu has an island-dotted structure on the Ti layer and contributes to size reduction of grains in the Ru layer.

Separately, a CoTaZr alloy layer, a CoTaZr alloy layer, a Ti layer, a Cu layer, and an Ru layer were sequentially formed in a similar manner. When the planar structure of the Ru layer was checked, as in Example 1, the grain boundary thickness was almost zero.

After that, the Ar gas pressure was raised to 2 Pa, and a multilayered magnetic recording layer was formed in accordance with the following procedure.

First, a nonmagnetic layer was formed by simultaneously sputtering Pt equivalent to a thickness of 0.8 nm and TiO₂ equivalent to a thickness of 0.2 nm. Next, a magnetic layer was formed by simultaneously sputtering Co equivalent to a thickness of 0.4 nm and TiO₂ equivalent to a thickness of 0.04 nm. At this time, the design value of the composition of the nonmagnetic layer is Pt—20 vol % TiO₂, and the design value of the composition of the magnetic layer is Co—10 vol % TiO₂.

After the above-described procedure was repeated eight times, a Pd layer having a thickness of 2 nm was further stacked on the final magnetic layer, thereby forming a multilayered magnetic recording layer.

Subsequently, a C protective layer having a thickness of 6 nm was stacked on the multilayered magnetic recording layer. In the obtained perpendicular magnetic recording medium, substrate/CoTaZr/Ru/CoTaZr/Ti/Cu/Ru/[Pt—20 vol % TiO₂/Co—10 vol % TiO₂]*8/Pd/C are stacked in this order.

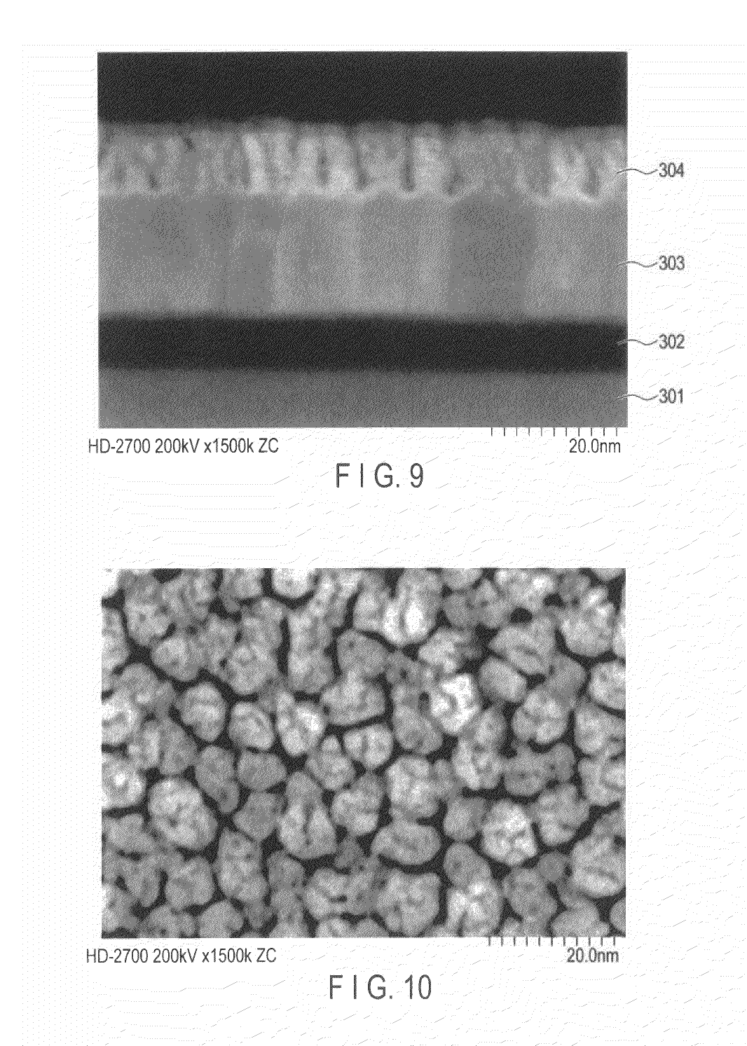

As for the sectional structure of the medium according to Example 3, FIG. 9 shows a dark field image (DF-STEM image) obtained by a scanning transmission electron microscopy.

In FIG. 9, CoTaZr 301/Ti 302/Ru 303/[Pt—20 vol % TiO₂/Co—10 vol % TiO₂]*8 304 can be identified. The stack of Cu between Ti/Ru and Pd/C on [Co—10 vol % TiO₂]*8 cannot be identified by the naked eye.

In the DF-STEM image, atoms whose average atomic number is small look dark. The atoms look whitish as the atomic number becomes large. Regions that look dark and are elongated in the film thickness direction in the multilayered magnetic recording layer are made of an oxide containing a large amount of O. As is apparent, a multilayer structure of Co that looks gray and Pt that looks whitish is formed. Roughness is observed on the surface of the Ru underlayer. Basically, portions that form valleys are grain boundaries. The Co/Pt crystal grains in the recording layer grow in the film thickens direction. The oxide appears to readily enter the position of the Ru grain boundary. As compared to FIG. 6 of Example 1, many columnar oxide regions can be observed. This is probably because adding TiO₂ not only to the Co layer but also to the Pt layer allows the oxide regions in the respective layers to easily connect and grow in a columnar shape. As a result, the volume of one lump of the oxide increases, and the pinning effect is expected to be enhanced.

As for the planar structure of the multilayered magnetic recording layer of the medium according to Example 3, FIG. 10 shows a dark field image (DF-STEM image) obtained by a scanning transmission electron microscopy.

In the DF-STEM image, atoms whose average atomic number is small look dark. The atoms look whitish as the atomic number becomes large. Whitish regions are made of magnetic grains having a multilayer structure of Co and Pt. Dark regions among the whitish regions are made of an oxide containing a large amount of O. An oxide region having a width of 1 nm or more is considered to extend through the recording layer. However, as can be seen from the section of FIG. 9, not all the oxide regions extend through the layer in the film thickness direction because of the multilayer structure. Black lines like cracks in the magnetic grains are estimated as a result of averaging the discontinuous oxide regions in the film thickness direction.

Although thick oxide layers are formed in the grain boundaries, each grain is partially connected to adjacent grains, as can be observed. Not a structure in which a grain boundary layer having an uniform thickness surrounds magnetic grains, as in an ideal granular structure, but an nonuniform structure in which portions where the oxide concentrates and portions where the grain boundary layer thickness is almost zero coexist is formed, as is apparent. In general, an oxide readily segregates in grain boundaries. However, when the grain boundary width is intentionally made nonuniform, it is assumed that the oxide regions are magnetically coupled at a portion where the grain boundary is narrow but function as pinning sites for pinning the domain wall at a portion where the oxide concentrates.

Depending on the manner the magnetic grains are connected, it is difficult to discriminate the range of one grain. However, the grain size is generally 10 nm or less, and fine magnetic grains can be formed, as is apparent. The recording layer structure including the nonuniform grain boundaries and fine grains is obtained by the effect of the underlayer formed by reducing the size of Ru grains and narrowing the grain boundaries using a low gas pressure.

When the magnetization curve of the medium of Example 3 was measured using a polar Kerr effect evaluation apparatus, Hc=3.1 kOe, Hn=2.8 kOe, and Hs=3.7 kOe. In the conventional granular type medium, when Hc=3.0 kOe, Hn≈1 kOe, and Hs≈5 kOe. The magnetic head cannot perform saturation recording without outputting a recording magnetic field greater than Hs. In the PPM, since Hs can be made much less than Hc, the recording easiness can be improved.

At this time, Ms is 360 emu/cc, and the slope α of the magnetization curve in Hc is about 14. The magnetic coupling in the film plane direction of the recording layer is very strong, and magnetization reversal is caused by domain wall displacement, as is apparent. In the planar STEM image of FIG. 10, the grains appear to be structurally connected. However, the grains are not magnetically isolated, either. This corresponds to the fact that the grains are magnetically coupled in the film plane direction.

When the recording/reproduction characteristic was evaluated as in Example 1, an excellent value of 20.2 dB was obtained as the signal-to-noise ratio of the medium of Example 3. It is revealed that the domain wall pinning effectively functioned, and a pattern with a steep magnetization change between bits could be recorded by the above-described structure and magnetic characteristic.

### Example 4

A perpendicular magnetic recording medium was formed under the same conditions as in Example 3 except that the Ru layer thickness was set to 10 nm and the content of TiO₂ added to the Pt layer was changed.

FIG. 11 shows the dependence of the coercive force Hc, the nucleation magnetic field Hn, and the saturation magnetic field Hs on the TiO₂ content.

In FIG. 11, curve 104 indicates the coercive force Hc, curve 105 indicates the nucleation magnetic field Hn, and curve 106 indicates the saturation magnetic field Hs.

As for the change in the Ru layer thickness, the increase/decrease with respect to the addition of TiO₂ does not exhibit a large change, and the same effect as in Example 1 can be obtained, although the absolute value of the coercive force Hc and the like change.

As can be seen from FIG. 11, Hc, Hn, and Hs increase similarly along with the increase in the TiO₂ content in the Pt layer, and are about two or more times at 20 vol % as large as those at 0 vol %. At this time, the differences between Hc, Hn, and Hs hardly change. This indicates that the slope of the magnetization curve in Hc maintains a large value, and magnetization reversal remains the same as that of the wall displacement type. The Hc increase in the domain wall displacement type indicates that the domain wall displacement is suppressed by adding TiO₂. It is believed that the oxide regions formed in the multilayered magnetic recording layer function as pinning sites. Note that when the TiO₂ content was 0 and 20 vol %, the slopes α of the magnetization curve in Hc were 28 and 22, respectively.

The recording/reproduction characteristic was evaluated as in Example 1. When the TiO₂ content in the Pt layer was 0 and 20 vol %, the signal-to-noise ratio was 5.3 dB and 19.0 dB, respectively. The signal-to-noise ratio when the TiO₂ content is 20 vol % is higher than that at 0 vol %, as a matter of course, and also higher than that in Example 1 or 2. This is probably because the volume of one lump of the oxide increases, and the pinning effect is enhanced, as described above concerning the sectional structure. As is apparent from these results, adding TiO₂ to the Pt layer can effectively improve the domain wall pinning, and a more excellent recording/reproduction characteristic can be obtained as compared to a case in which TiO₂ is added only to the Co layer.

### Comparative Example 1

First, a CoTaZr alloy layer having a thickness of 20 nm, a Ru layer having a thickness of 0.8 nm, and a CoTaZr alloy layer having a thickness of 20 nm were sequentially formed on a nonmagnetic substrate as a soft magnetic underlayer. Note that the two CoTaZr layers are anti-ferromagnetically coupled via the Ru layer provided between them. A Ti layer having a thickness of 8 nm and Cu equivalent to a thickness of 1 nm were formed on the CoTaZr layer. Next, an Ru layer having a thickness of 10 nm was formed without changing an Ar gas pressure of 0.6 Pa, and another Ru layer having a thickness of 10 nm was formed on it layer after raising the Ar gas pressure to 6 Pa, thus forming the Ru layer having a total thickness of 20 nm and serving as an underlayer. This underlayer forming method is the same as in the conventional granular medium. A state was observed by TEM analysis in which grain boundaries each having a width of about 0.5 nm or more were formed between the Ru grains by the high gas pressure film formation.

After that, the Ar gas pressure was raised to 3 Pa, and a multilayered magnetic recording layer was formed in accordance with the following procedure.

First, a nonmagnetic layer was formed by simultaneously sputtering Pt equivalent to a thickness of 0.54 nm and [Co—3 at % Cr]—8 mol % SiO₂ equivalent to a thickness of 0.37 nm. Next, a [Co—3 at % Cr]—8 mol % SiO₂ magnetic layer having a thickness of 0.6 nm was formed. Since SiO₂ was added to both the layer containing Pt as the main component and the layer containing Co as the main component, the oxide regions in the layers are connected and grow in a columnar shape. In this comparative example, since the gaps are provided between the Ru grains of the underlayer, and the forming method using the CoCr—SiO₂ target as in the conventional granular medium is used, the oxide of the recording layer is readily uniformly formed between the magnetic grains, and separation of the magnetic grains proceeds.

After the above-described procedure was repeated eight times, a Pd layer having a thickness of 2 nm was further stacked on the final magnetic layer, thereby forming a multilayered magnetic recording layer. Subsequently, a C protective layer having a thickness of 6 nm was stacked on the multilayered magnetic recording layer.

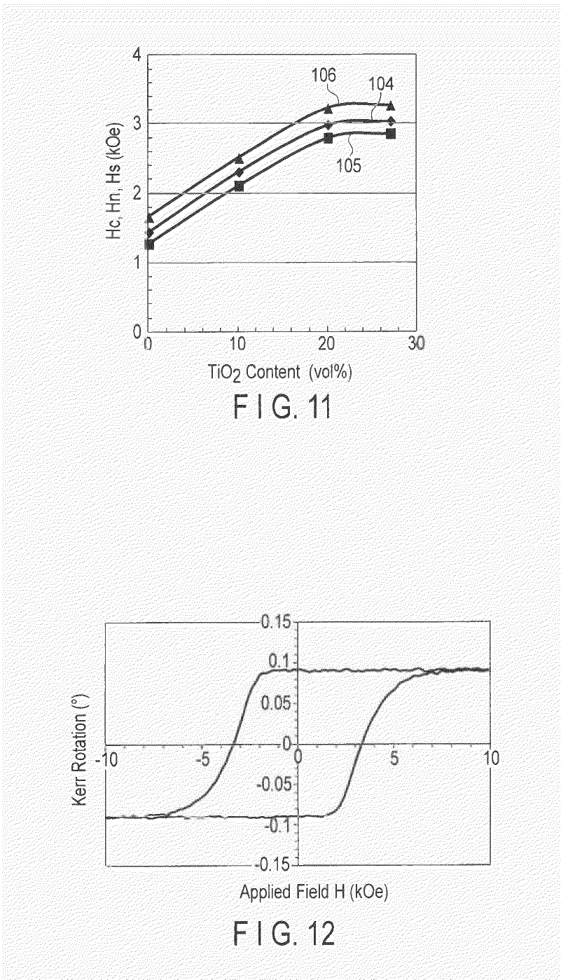

FIG. 12 shows the magnetization curve of the medium of Comparative Example 1 measured by a polar Kerr effect evaluation apparatus.

As the magnetic characteristic, Hc=3.3 kOe, Hn=2.1 kOe, and Hs=7.2 kOe. Ms was 470 emu/cc. The slope α of the magnetization curve in Hc was about 4.8. It can be estimated that when the slope α decreases to this extent, the magnetization reversal mode is closer to the magnetization rotation type than the domain wall displacement type because of the characteristic representing that the magnetization is saturated with tailing near Hs. Such a structure in which the magnetic coupling between the magnetic grains appears to be weak is supposed to correspond to a structure in which structural separation of the magnetic grains proceeds. In the multilayered magnetic film in which the magnetic coupling readily becomes strong in the film plane direction, however, it is difficult to form a structure in which the magnetic grains are uniformly isolated, as in a conventional Co alloy granular structure. On the other hand, it is known well that the signal-to-noise ratio decreases when the coupling between the grains is strengthened using a granular structure as a base to decrease the saturation magnetic field Hs to facilitate recording by the head. The strength of the coupling between the grains can be adjusted by the content of the oxide. However, since the oxide readily enters the grain boundaries, the thickness of the grain boundary layer only changes. For this reason, it is difficult to simultaneously attain recording easiness and improve the signal-to-noise ratio using the structure and magnetic characteristic of Comparative Example 1 as a base.

### Comparative Example 2

First, an NiTa alloy layer having a thickness of 10 nm was formed on a nonmagnetic substrate in place of a soft magnetic underlayer.

Next, a Pd layer having a thickness of 12 nm, an Ru layer having a thickness of 10 nm, and a Ti layer having a thickness of 5 nm were sequentially stacked on the NiTa layer without changing an Ar gas pressure of 0.6 Pa.

After the Ar gas pressure was raised to 2 Pa, a multilayered magnetic recording layer was formed in accordance with the following procedure.

First, a Pt nonmagnetic layer having a thickness of 0.8 nm was formed. Next, a magnetic layer was formed by simultaneously sputtering Co equivalent to a thickness of 0.4 nm and TiO whose film formation amount was changed. After the above-described procedure was repeated eight times, a Pd layer having a thickness of 2 nm was further stacked on the final magnetic layer, thereby forming a multilayered magnetic recording layer. Subsequently, a C protective layer having a thickness of 6 nm was stacked on the multilayered magnetic recording layer.

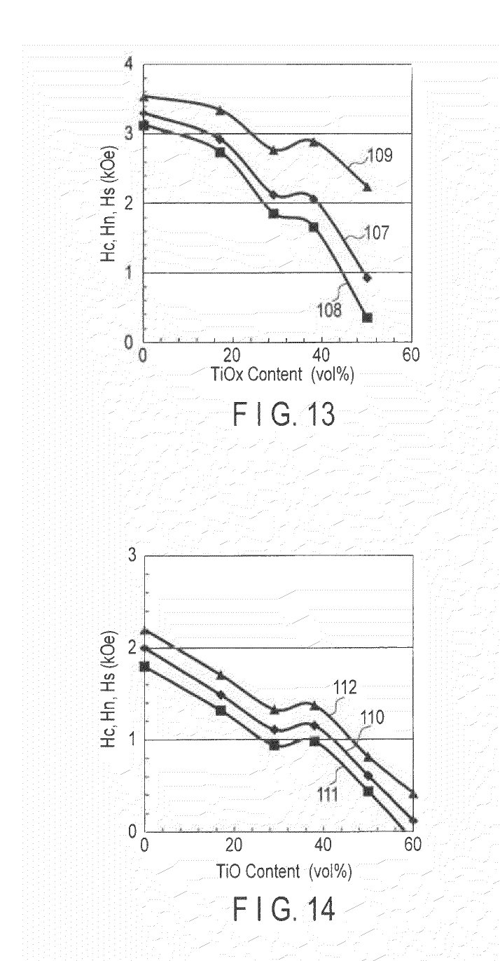

FIG. 13 shows the dependence of the coercive force Hc, the nucleation magnetic field Hn, and the saturation magnetic field Hs on the TiO content.

In FIG. 13, curve 107 indicates the coercive force Hc, curve 108 indicates the nucleation magnetic field Hn, and curve 109 indicates the saturation magnetic field Hs.

In a state in which no TiO is added, the difference between Hn and Hs is small, and the slope of the magnetization curve in Hc is large. This reveals that the coupling between the magnetic grains is strong, and magnetization reversal is of a domain wall displacement type. On the other hand, as the TiO content increases, the difference between Hn and Hs becomes large, and the slope of the magnetization curve in Hc becomes small. The coupling between the magnetic grains weakens, and magnetization reversal changes to the magnetization rotation type, as can be observed. Such a change is a tendency observed in general in the conventional Co alloy granular medium. Since the oxide readily segregates to surround the crystal grains, the magnetic isolation of the magnetic grains is prompted.

Note that the decrease in He caused by the addition of TiO is accounted for by the effect of the underlayer. In Comparative Example 2, the Ti layer is sandwiched between the Ru layer and the multilayered magnetic recording layer. However, there is a room for improvement of the underlayer.

### Comparative Example 3

A perpendicular magnetic recording medium was formed under the same conditions as in Comparative Example 2 except that the Pd seed layer portion was replaced with a Ti layer having a thickness of 8 nm and Cu equivalent to a thickness of 1 nm. Cu has an island-dotted structure on the Ti layer and contributes to size reduction of grains in the Ru layer.

FIG. 14 shows the dependence of the coercive force Hc, the nucleation magnetic field Hn, and the saturation magnetic field Hs on the TiO content.

In FIG. 14, curve 110 indicates the coercive force Hc, curve 111 indicates the nucleation magnetic field Hn, and curve 112 indicates the saturation magnetic field Hs.

The tendency of Hc that decreases with respect to the TiO content is similar to Comparative Example 2. The absolute value of Hc decreases because the seed layer is changed. However, even when the oxide content is increased, the difference between Hn and Hs does not become large, and a state in which the slope of the magnetization curve in Hc is large is maintained, as can be seen. The change in the magnetic characteristic indicates that the grains in the recording layer are not magnetically isolated, and the oxide does not sufficiently surround the crystal grains. The difference between Comparative Example 2 and Comparative Example 3 is only the seed layer. It is therefore believed that the oxide in the recording layer can hardly uniformly form the grain boundaries because of reduction of the grain size in the underlayer.

This tendency is not conventionally observed in general. Based on this result, the possibility of implementing a medium of a domain wall displacement type using an oxide as pinning sites by controlling the structure of the underlayer was explored. To pin the domain wall, the domain wall needs to be thinner than the pinning sites. Since a multilayered magnetic film like [Co/Pt] can obtain a high perpendicular magnetic anisotropy, the domain wall can be made thin. In addition, since the magnetic coupling in the film plane direction is strong, the magnetization reversal mode hardly changes from the domain wall displacement even when the oxide amount is increased. Since the recording layer is formed by divisionally forming a number of thin layers, an advantage that, for example, the arrangement of the oxide can easily be controlled can be expected.

It is considered difficult to simultaneously attain recording easiness and a high recording density using the oxide granular structure and the magnetic characteristic as in Comparative Example 1. However, seen from a different perspective, a medium capable of forming a fine domain wall having a small saturation magnetic field Hs can probably be realized by combining an underlayer that cannot be used for a granular structure because the oxide readily becomes nonuniform, a multilayered magnetic film of a domain wall displacement type different from the granular medium, and an oxide that readily segregates in grain boundaries with respect to metal grains. The medium as in Example 1 or 3 can be formed in this way. It is therefore possible to provide a perpendicular magnetic recording medium capable of simultaneously attaining recording easiness and a high recording density and a magnetic recording/reproducing device using the perpendicular magnetic recording medium.

Note that in the embodiment, since a medium of a domain wall displacement type is assumed, a medium in which the slope of the magnetization curve is less than 5 as in Comparative Example 1 cannot be used.

### Comparative Example 4

A medium of Comparative Example 4 was formed in the following way.

First, a CoTaZr alloy layer having a thickness of 20 nm, a Ru layer having a thickness of 0.8 nm, and a CoTaZr alloy layer having a thickness of 20 nm were sequentially formed on a nonmagnetic substrate as a soft magnetic underlayer. Note that the two CoTaZr layers are anti-ferromagnetically coupled via the Ru layer provided between them. A Pd layer having a thickness of 12 nm, an Ru layer having a thickness of 10 nm, and a Ti layer having a thickness of 5 nm were sequentially stacked on the CoTaZr layer without changing an Ar gas pressure of 0.6 Pa.

After the Ar gas pressure was raised to 3 Pa, a multilayered magnetic recording layer was formed in accordance with the following procedure.

First, Ag equivalent to a thickness of 0.4 nm was sputtered. Next, a Pt layer having a thickness of 0.8 nm was formed. In addition, a Co layer having a thickness of 0.4 nm was stacked. After the above-described procedure was repeated eight times, a Pd layer having a thickness of 2 nm was further stacked on the final Co layer, thereby forming a multilayered magnetic recording layer.

Subsequently, a C protective layer having a thickness of 6 nm was stacked on the multilayered magnetic recording layer.

When the magnetization curve of the medium of Comparative Example 4 was measured using a polar Kerr effect evaluation apparatus, Hc=5.8 kOe, Hn=5.5 kOe, and Hs=6.7 kOe. This medium is also of a domain wall displacement type. Although Hc is high, Hs is small relatively. Ag that is a nonmagnetic metal is dispersed in the recording layer and functions as pinning site.

The recording/reproduction characteristic was evaluated as in Example 1. The signal-to-noise ratio of the medium of Comparative Example 4 was 13.0 dB. As is apparent, the medium of Example 1 or 3 according to the embodiment can improve the signal-to-noise ratio largely than the medium of Comparative Example 4.

### Example 5

First, an NiTa alloy layer having a thickness of 10 nm was formed on a nonmagnetic substrate in place of a soft magnetic underlayer. Next, an Al—44 at % Si layer having a thickness of 5 nm and a Pd layer having a thickness of 6 nm were sequentially formed on the NiTa layer. An Ru layer having a thickness of 10 nm was then formed without changing an Ar gas pressure of 0.6 Pa, another Ru layer having a thickness of 10 nm was formed on it layer after changing the Ar gas pressure to 0.6 to 2 Pa, thus forming the Ru layer having a total thickness of 20 nm and serving as an underlayer. The AlSi layer and the Pd layer react with reach other to form a compound and contributes to size reduction of grains in the Ru layer. When the upper half portion of the Ru layer is formed after raising the Ar gas pressure, gaps are readily formed between the Ru grains. When a magnetic layer containing an oxide is formed on it, separation of the magnetic grains tends to be prompted.

A perpendicular magnetic recording medium was formed in accordance with the same procedure as in Example 3 for the multilayered magnetic recording layer and the like. In the obtained perpendicular magnetic recording medium, substrate/NiTa/AlSi/Pd/Ru/[Pt—20 vol % TiO₂/Co—10 vol % TiO₂]*8/Pd/C are stacked in this order.

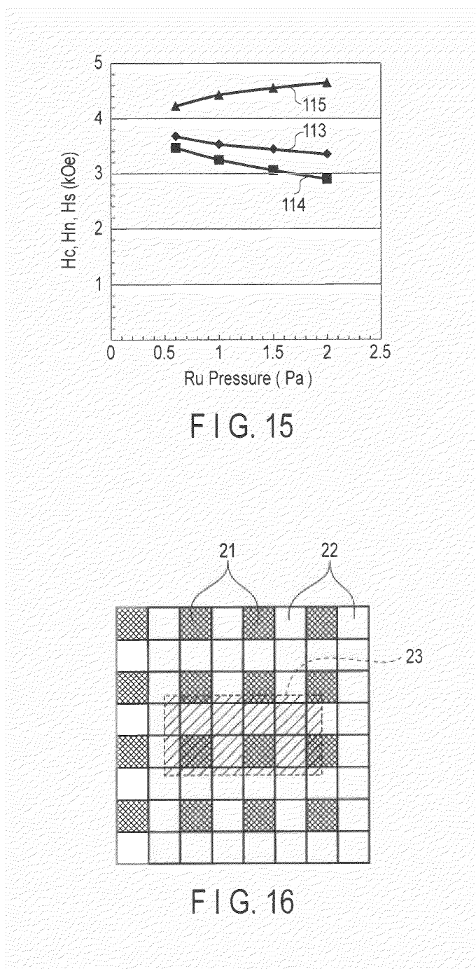

FIG. 15 shows the dependence of the coercive force Hc, the nucleation magnetic field Hn, and the saturation magnetic field Hs on the Ar gas pressure at the time of Ru underlayer formation.

In FIG. 15, curve 113 indicates the coercive force Hc, curve 114 indicates the nucleation magnetic field Hn, and curve 115 indicates the saturation magnetic field Hs.

As the Ar gas pressure rises, the difference between Hn and Hs tends to become large. This is similar to the case of the conventional Co alloy granular medium in which when the gaps between the Ru grains become large, separation of the magnetic grains is prompted from the initial stage of recording layer growth. On the other hand, in the conventional granular medium, Hc increases as the isolation progresses from the state in which the coupling of the grains is strong. In the medium of Example 5, conversely, Hc shows a tendency to decrease. This is probably associated with the structure of the multilayered magnetic recording layer in which the oxide nonuniformly segregates, as described above. The tendency to decrease Hc and α is undesirable.

The recording/reproduction characteristic was evaluated as in Example 1. When the Ar gas pressures were 0.6, 1.5, and 2 Pa, the signal-to-noise ratios were 20.5, 20.4, and 19.2 dB, respectively. The signal-to-noise ratio at 2 Pa is not bad as an absolute value. However, in addition to the tendency that the magnetic characteristic gradually degrades, the signal-to-noise ratio obviously decreases from that at 1.5 Pa. Hence, the Ar gas pressure when forming the Ru layer can be 1.5 Pa or less.

### Example 6

A perpendicular magnetic recording medium was formed under the same conditions as in Example 3 except that the oxide added to the Co layer was changed from TiO₂ to TiO, and the design value of the composition was set to [Pt—20 vol % TiO₂/Co—20 vol % TiO]. Since TiO₂ is an insulator, RF sputtering is necessary. However, TiO can be because it causes DC discharge and is therefore conveniently used from the viewpoint of manufacturing process. When the recording/reproduction characteristic was evaluated as in Example 1, an excellent value of 20.0 dB was obtained as the signal-to-noise ratio of the medium of Example 6.

### Example 7

A perpendicular magnetic recording medium was formed under the same conditions as in Example 2 except that the Ru layer thickness was changed to 10 nm, TiO₂ in the multilayered magnetic recording layer was changed to SiO₂, and the SiO₂ content in the Co layer was changed.

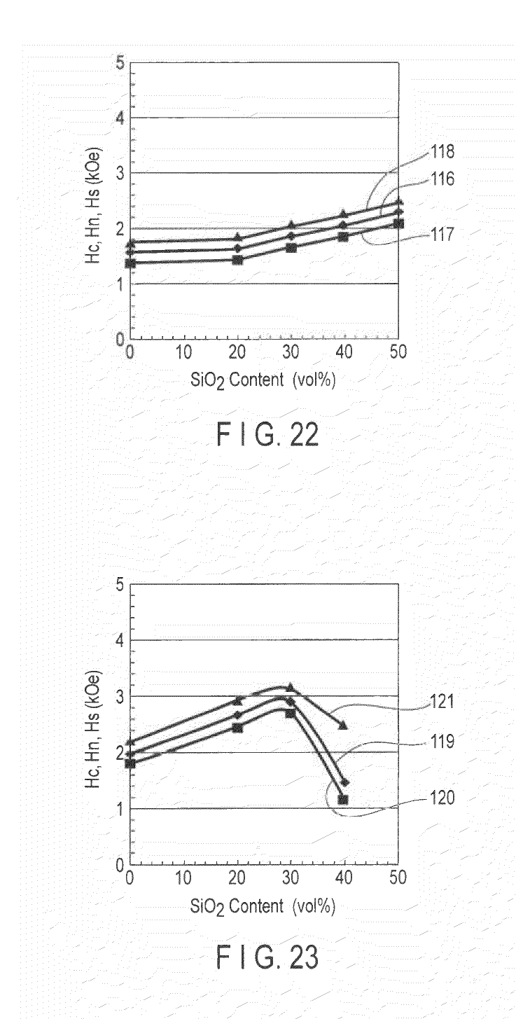

FIG. 22 shows the dependence of the coercive force Hc, the nucleation magnetic field Hn, and the saturation magnetic field Hs on the SiO₂ content.

In FIG. 22, curve 116 indicates the coercive force Hc, curve 117 indicates the nucleation magnetic field Hn, and curve 118 indicates the saturation magnetic field Hs.

As for the change in the Ru layer thickness, the increase/decrease of the coercive force Hc with respect to the addition of SiO₂ does not exhibit a large change, and the same effect as in Example 2 can be obtained, although the absolute values of the Hc and the like change.

In case of SiO₂, Hc continuously increased even when the content was increased up to 50 vol % in design value. The tendency of Hc that turned to a decrease in TiO₂ was not observed. When SiO₂ can be added in a large amount, the pinning sites can easily be made large. For this reason, SiO₂ is believed to be one of preferable materials.

When the recording/reproduction characteristic of the perpendicular magnetic recording medium whose multilayered magnetic recording layer was [Pt/Co—50 vol % SiO₂] was evaluated as in Example 1, SNR was 14.0 dB. Although the SNR was lower as compared to that in TiO₂ addition, an excellent recording/reproduction characteristic was obtained by adding SiO₂ to the Co layer.

A perpendicular magnetic recording medium was formed under the same conditions as in Example 3 except that TiO₂ in the multilayered magnetic recording layer was changed to SiO₂, and the SiO₂ content in the Pt layer was changed.

FIG. 23 shows the dependence of the coercive force Hc, the nucleation magnetic field Hn, and the saturation magnetic field Hs on the SiO₂ content.

In FIG. 23, curve 119 indicates the coercive force Hc, curve 120 indicates the nucleation magnetic field Hn, and curve 121 indicates the saturation magnetic field Hs.

As can be seen from FIG. 23, Hc tends to increase up to 30 vol %, and the pinning effect of the domain wall can be obtained even when the oxide is SiO₂.

When the recording/reproduction characteristic of the perpendicular magnetic recording medium whose multilayered magnetic recording layer was [Pt—30 vol % SiO₂/Co—30 vol % SiO₂] was evaluated as in Example 1, SNR was 15.5 dB. Although the SNR was lower as compared to that in TiO₂ addition, an excellent recording/reproduction characteristic was obtained by adding SiO₂ to the Pt layer.

### Example 8

A perpendicular magnetic recording medium was formed under the same conditions as in Example 2 except that TiO₂ in the multilayered magnetic recording layer was changed to WO₃, and the WO₃ content in the Co layer was changed.

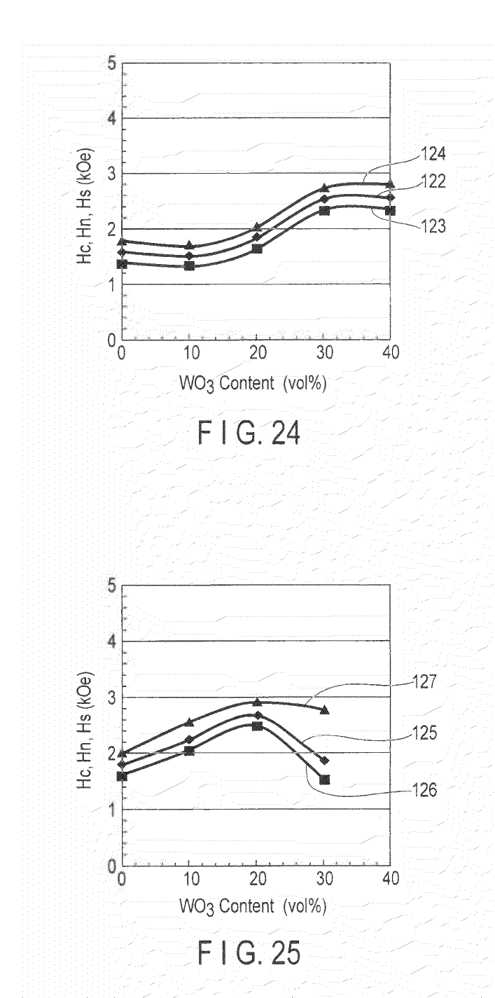

FIG. 24 shows the dependence of the coercive force Hc, the nucleation magnetic field Hn, and the saturation magnetic field Hs on the WO₃ content.

In FIG. 24, curve 122 indicates the coercive force Hc, curve 123 indicates the nucleation magnetic field Hn, and curve 124 indicates the saturation magnetic field Hs.

As can be seen from FIG. 24, Hc obviously increases when the content is 30 to 40 vol %, and the pinning effect of the domain wall can be obtained even when the oxide is WO₃.

When the recording/reproduction characteristic of the perpendicular magnetic recording medium whose multilayered magnetic recording layer was [Pt/Co 50 vol % WO₃] was evaluated as in Example 1, SNR was 18.9 dB. An excellent recording/reproduction characteristic as in TiO₂ addition was obtained by adding WO₃ to the Co layer.

A perpendicular magnetic recording medium was formed under the same conditions as in Example 3 except that TiO₂ in the multilayered magnetic recording layer was changed to WO₃, and the WO₃ content in the Pt layer was changed.

FIG. 25 shows the dependence of the coercive force Hc, the nucleation magnetic field Hn, and the saturation magnetic field Hs on the WO₃ content.

In FIG. 25, curve 125 indicates the coercive force Hc, curve 126 indicates the nucleation magnetic field Hn, and curve 127 indicates the saturation magnetic field Hs.

As can be seen from FIG. 25, Hc tends to increase up to 20 vol %, and the pinning effect of the domain wall can be obtained even when the oxide is WO₃.

When the recording/reproduction characteristic of the perpendicular magnetic recording medium whose multilayered magnetic recording layer was [Pt—20 vol % WO₃/Co—30 vol % WO₃] was evaluated as in Example 1, SNR was 19.1 dB. An excellent recording/reproduction characteristic as in TiO₂ addition was obtained by adding WO₃ to the Pt layer.

### Example 9

A perpendicular magnetic recording medium was formed under the same conditions as in Example 2 except that the Ar gas pressure for the multilayered magnetic recording layer was changed to 3 Pa, TiO₂ in the multilayered magnetic recording layer was changed to Ta₂O₅, and the Ta₂O₅ content in the Co layer was changed.

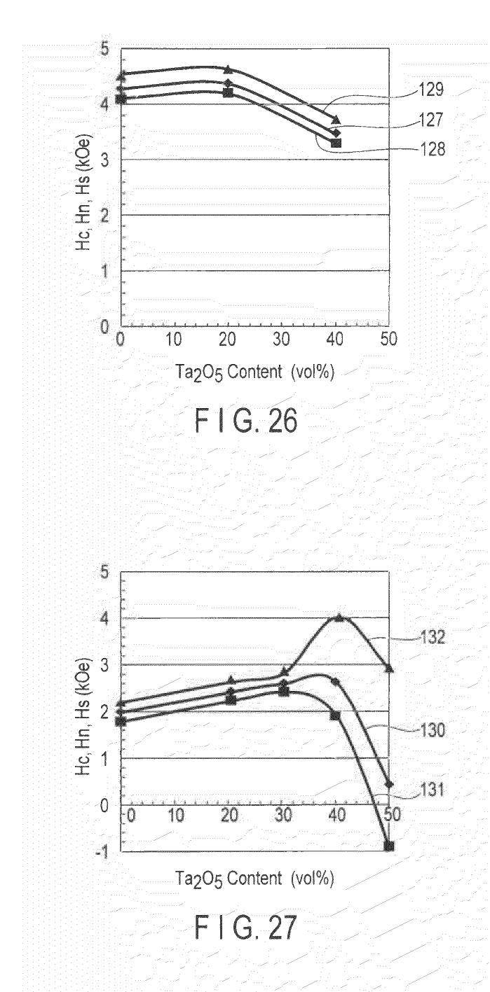

FIG. 26 shows the dependence of the coercive force Hc, the nucleation magnetic field Hn, and the saturation magnetic field Hs on the Ta₂O₅ content.

In FIG. 26, curve 127 indicates the coercive force Hc, curve 128 indicates the nucleation magnetic field Hn, and curve 129 indicates the saturation magnetic field Hs.

When the Ar pressure is raised, the increase amount of Hc tends to be small. For this reason, no obvious increase of Hc is observed. However, at least Hc was maintained up to 20 vol %, and the decrease at 40 vol % was not so large.

When the recording/reproduction characteristic of the perpendicular magnetic recording medium whose multilayered magnetic recording layer was [Pt/Co—20 vol % Ta₂O₅] was evaluated as in Example 1, SNR was 17.1 dB. Although the SNR was lower a little as compared to that in TiO₂ addition, an excellent recording/reproduction characteristic was obtained by adding Ta₂O₅ to the Co layer.

A perpendicular magnetic recording medium was formed under the same conditions as in Example 3 except that TiO₂ in the multilayered magnetic recording layer was changed to Ta₂O₅, and the Ta₂O₅ content in the Pt layer was changed.

FIG. 27 shows the dependence of the coercive force Hc, the nucleation magnetic field Hn, and the saturation magnetic field Hs on the Ta₂O₅ content.

In FIG. 27, curve 130 indicates the coercive force Hc, curve 131 indicates the nucleation magnetic field Hn, and curve 132 indicates the saturation magnetic field Hs.

As is apparent from FIG. 27, Hc increased up to 30 vol % while maintaining the large slope of the magnetization curve. However, when the content increased more, the difference between Hs and Hn became large. That is, the slope of the magnetization curve tends to be small. It is believed that when Ta₂O₅ is added to the Pt layer too much, the segregation progresses so as to decouple the magnetic particles.

When the recording/reproduction characteristic of the perpendicular magnetic recording medium whose multilayered magnetic recording layer was [Pt—40 vol % Ta₂O₅/Co—20 vol % Ta₂O₅] was evaluated as in Example 1, SNR was 19.1 dB. An excellent recording/reproduction characteristic as in TiO₂ addition was obtained by adding Ta₂O₅ to the Pt layer.

### Example 10

A perpendicular magnetic recording medium was formed under the same conditions as in Example 2 except that TiO₂ in the multilayered magnetic recording layer was changed to CoO, and the CoO content in the Co layer was changed.

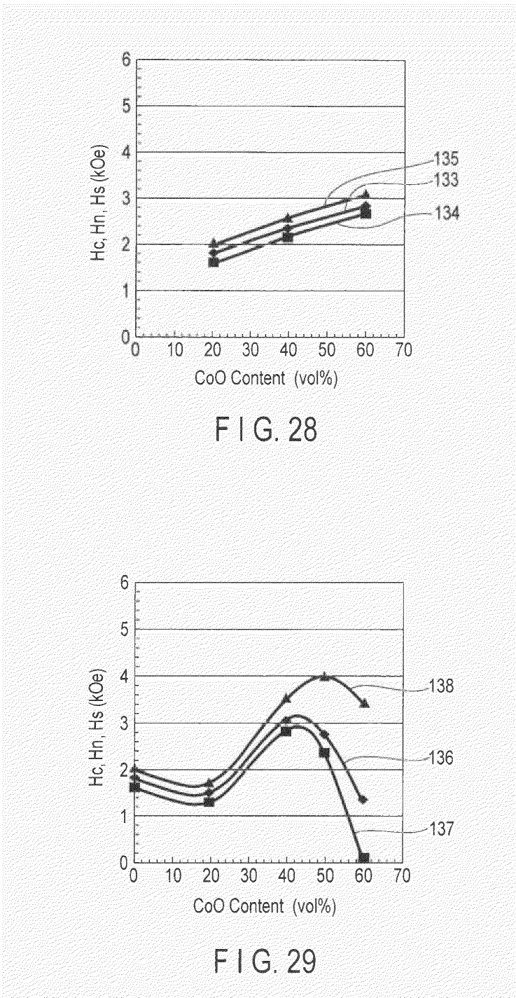

FIG. 28 shows the dependence of the coercive force Hc, the nucleation magnetic field Hn, and the saturation magnetic field Hs on the Coo content.

In FIG. 28, curve 133 indicates the coercive force Hc, curve 134 indicates the nucleation magnetic field Hn, and curve 135 indicates the saturation magnetic field Hs.

As can be seen from FIG. 28, Hc tends to increase along with the increase in the content, and the pinning effect of the domain wall can be obtained even when the oxide is CoO. Note that CoO is also believed to be decomposed by sputtering into Co and O and then increase the thickness of Co magnetic layer or oxidize the Co in original Co layer. However, since Ms is rarely changed by the CoO content, the grain boundary substances are considered to increase in accordance with the content.

When the recording/reproduction characteristic of the perpendicular magnetic recording medium whose multilayered magnetic recording layer was [Pt/Co—60 vol % CoO] was evaluated as in Example 1, SNR was 17.7 dB. An excellent recording/reproduction characteristic as in TiO₂ addition was obtained by adding CoO to the Co layer.

A perpendicular magnetic recording medium was formed under the same conditions as in Example 3 except that TiO₂ in the multilayered magnetic recording layer was changed to CoO, and the CoO content in the Pt layer was changed.

FIG. 29 shows the dependence of the coercive force Hc, the nucleation magnetic field Hn, and the saturation magnetic field Hs on the CoO content.

In FIG. 29, curve 136 indicates the coercive force Hc, curve 137 indicates the nucleation magnetic field Hn, and curve 138 indicates the saturation magnetic field Hs.

As can be seen from FIG. 29, Hc increased up to 40 vol % while maintaining the large slope of the magnetization curve. After that, when the content increased more, the difference between Hs and Hn became large. That is, the slope of the magnetization curve tends to be small. It is believed that when CoO is added to the Pt layer too much, the segregation progresses so as to decouple the magnetic particles.

When the recording/reproduction characteristic of the perpendicular magnetic recording medium whose multilayered magnetic recording layer was [Pt—40 vol % CoO/Co—40 vol % CoO] was evaluated as in Example 1, SNR was 19.3 dB. An excellent recording/reproduction characteristic as in TiO₂ addition was obtained by adding CoO to the Pt layer.

### Example 11

A perpendicular magnetic recording medium was formed under the same conditions as in Example 1 except that Pt in the multilayered magnetic recording layer was changed to Pd. When the recording/reproduction characteristic was evaluated as in Example 1, the signal-to-noise ratio of the medium of Example 11 was 16.1 dB. The signal-to-noise ratio is less than that when Pt is used. However, the [Co/Pd] multilayered film tends to obtain a higher perpendicular magnetic anisotropy than [Co/Pt]. Hence, Pd is considered to be one of those materials that can be used.

### Example 12

### Micromagnetics Simulation

To check bit recording and stability in the 3 Tbits/inch² class, micromagnetics simulation was conducted using the commercially available LLG Micromagnetics Simulator software (M. R. Scheinfein et al). The calculation model had a size of 32×32×8 nm and was divided into cubic cells as large as 1 nm per side. Since a periodic boundary condition is applied in the in-plane direction, a demagnetizing field as in a case in which the film surface is infinitely wide can be obtained. The size of one grain in the plane is based on a rectangle as large as 4 nm per side. The pinning sites have a structure in which magnetization is eliminated for every other grain.

FIG. 16 is a view showing a micromagnetics simulation calculation model viewed from the upper side, which is an example of the perpendicular magnetic recording medium according to the embodiment.

Reference numeral 21 denotes a pinning site, and a portion 22 is assumed to be a magnetic grain as large as 4 nm per side. The inside of each magnetic grain 22 was divided into cubic cells (not shown) as large as 1 nm per side. The exchange stiffness constant was A=0.5 or 1 μerg/cm between the cells (corresponding to the inside of a magnetic grain) and A=0.5 μerg/cm between the grains. Ms=1000 emu/cc. A dispersion of the orientation distribution of the axis of easy magnetization was set to Δθ50=5°. The Gilbert attenuation coefficient α was 1, and the temperature was set to 300 K in consideration of thermal decay. A head magnetic field was applied to a rectangular region 23 having a size of 20×10 nm indicated by the dotted line at the center of the model for 0.1 ns. After that, the magnetization state 0.1 ns after the head magnetic field was stopped was calculated.

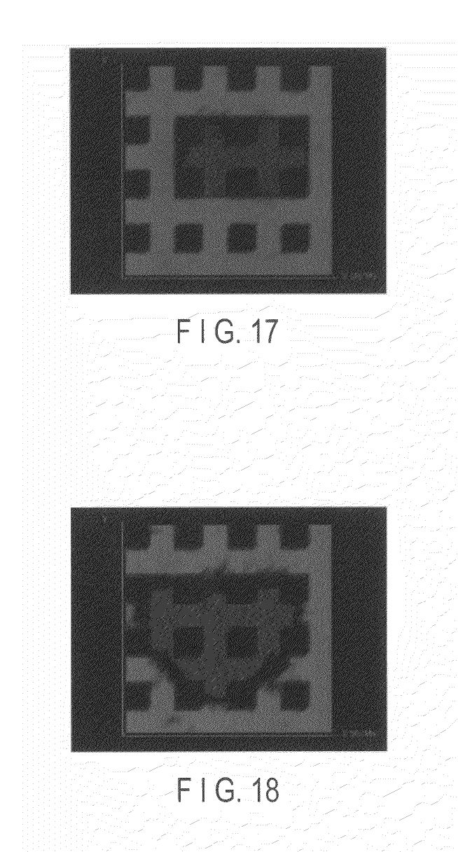

FIG. 17 shows an image of an example of a micromagnetics simulation calculation model in the in-plane direction of an example of the perpendicular magnetic recording medium according to the first embodiment including columnar pinning sites.

This calculation result was obtained by setting the exchange stiffness constants to A=1 μerg/cm between the cells and A=0.5 μerg/cm between the grains and Ku=4×10⁷ erg/cc.

The black portions indicate pinning sites, the red portions indicate magnetic grains exhibiting upward spin, and the blue portions indicate magnetic grains exhibiting downward spin.

Compared with experiments, the magnitude of the exchange stiffness constant A is not clear partly because of the dependence on the cell size, and a value of 1 μerg/cm often used for a Co-based material was employed. The exchange stiffness constant between the grains is 1/2, which experimentally corresponds to a case in which the Ar gas pressure is raised to weaken the coupling between the grains and increase Hc. The position of the domain is shifted from the position where recording is performed to the position where the domain is readily fixed by the pinning site. As is apparent, a rectangular domain is stably formed. The domain size slightly increases to 20×12 nm. When pinning sites having a diameter of about 4 nm are arranged at a areal density of about 25% when Ku=4×10⁷ erg/cc, bits in the 3 Tbits/inch² class can stably be held even at room temperature, as can be seen. It is therefore possible to provide a perpendicular magnetic recording medium capable of simultaneously attaining a high areal recording density and a high thermal stability using a continuous film including pinning sites as a magnetic recording layer and a magnetic recording/reproducing device using the perpendicular magnetic recording medium.

FIG. 18 shows an image of another example of a micromagnetics simulation calculation model in the in-plane direction of an example of the perpendicular magnetic recording medium according to the first embodiment including columnar pinning sites.

FIG. 18 shows a calculation result obtained by setting the exchange stiffness constant to A=0.5 μerg/cm both between the cells and between the grains and Ku=3×10⁷ erg/cc. Since a result close to the experiments may be obtained by reducing A in the grains to about 0.5 μerg/cm according to comparison with several experiments and calculations, calculation using A=0.5 μerg/cm was also performed. The domain is stable when the exchange stiffness constant A between the grains is less than that in the grains, as is known. However, the calculation was done intentionally on a strict condition that the coupling between the grains is sufficiently strong (a magnetically even continuous film is formed). As is apparent from comparison between the periphery of the domain in FIG. 18 and that in FIG. 21, the domain is stably held without becoming small along with the elapse of time, although the domain wall is not stopped by the grain boundaries, and the boundary is not clear. As can be seen, since the domain size is slightly large, small bits can stably be held even at room temperature under the strict condition that the coupling between the grains is not weak, although the areal recording density is less than 3 Tbits/inch². It is therefore possible to provide a perpendicular magnetic recording medium capable of simultaneously attaining a high areal recording density and a high thermal stability using a continuous film including pinning sites as a magnetic recording layer and a magnetic recording/reproducing device using the perpendicular magnetic recording medium.

Calculation was done for a case in which a layer having a thickness of 8 nm was divided into two 4-nm thick layers, and the positions of the pinning sites were changed between the upper and lower layers.

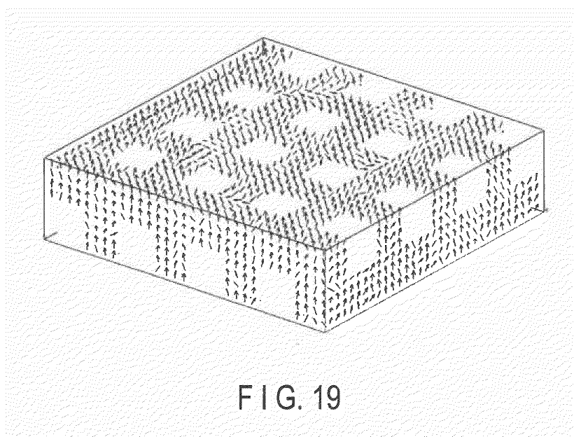

FIG. 19 is a perspective view showing a micromagnetics simulation calculation model of an example of the perpendicular magnetic recording medium according to the second embodiment.

Note that each arrow indicates the magnetic moment of the center of a cell.

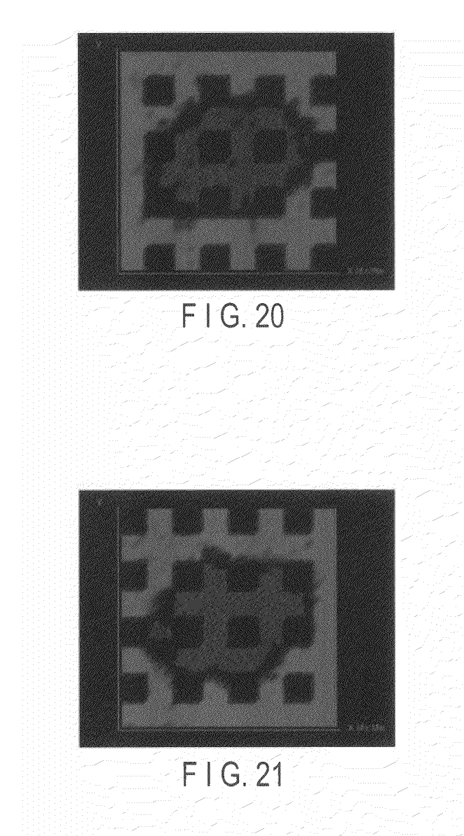

FIG. 20 shows an image of an example of the micromagnetics simulation calculation model of the upper layer shown in FIG. 19.

FIG. 21 shows an image of an example of the micromagnetics simulation calculation model of the lower layer shown in FIG. 19.

The exchange stiffness constant was set to A=0.5 μerg/cm both between the cells and between the grains, and the magnetic anisotropy constant Ku was set to Ku=3×10⁷ erg/cc basically as in FIG. 18. However, the exchange coupling between the upper and lower layers was set relatively weak to 0.2 μerg/cm. This calculation condition assumes a state in which the magnetic layers are weakly coupled via a nonmagnetic layer in the multilayered magnetic recording layer, and the pinning sites are not formed into a columnar shape but three-dimensionally dotted.

FIG. 20 shows the domain in the layer having thickness of 4 to 5 nm immediately above the interface, and FIG. 21 shows the domain in the layer having thickness of 3 to 4 nm immediately under the interface. Even when the pinning site positions change between the upper and lower layers, the domain positions overlap, as can be seen. The effect of introducing the interlayer coupling is obtained, as is apparent, because the domain positions are shifted between the upper and lower layers without the interlayer coupling. There was a concern about weakening of the pinning force in the thinned film. However, no obvious increase in the width of the transition region was observed, as compared to FIG. 18.

Focusing on portions where a film exists on or under one pinning site at the domain boundary in FIGS. 20 and 21, the domain does not particularly spread at the film portion, as can be seen. For this reason, even when the pinning sites are formed only in the magnetic layer portions, the domain wall may wrap around on and under the pinning sites, including, for example, diffusion of Co in the Pt layer. It is therefore possible to provide a perpendicular magnetic recording medium capable of simultaneously attaining a high areal recording density and a high thermal stability even when the pinning sites neither exist in the nonmagnetic layers nor extend through the magnetic layers in a columnar shape, as shown in FIG. 2, and a magnetic recording/reproducing device using the perpendicular magnetic recording medium.

According to the embodiment, a multilayered film including pinning sites in a magnetic recording layer is used as a non-processed continuous medium having a flat surface and ensuring satisfactory head floating.

This makes it possible to provide a perpendicular magnetic recording medium capable of simultaneously attaining a high thermal stability and recording easiness and obtaining a high areal recording density, and a magnetic recording/reproducing device using the perpendicular magnetic recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A perpendicular magnetic recording medium comprising:
a substrate; and
an underlayer provided on the substrate, made of crystal grains in which a width of a grain boundary between the crystal grains is less than 0.5 nm; and
a multilayered magnetic recording layer formed in contact with the underlayer, and including at least two magnetic layers and two nonmagnetic layers which are alternately stacked,
wherein the magnetic layer comprises a magnetically continuous film which is made of magnetic crystal grains mainly containing Co and an oxide dispersed in the entire magnetic layer, includes a plurality of pinning sites capable of pinning a domain wall, and is exchange-coupled in an in-plane direction in the entire magnetic recording layer, and
the perpendicular magnetic recording medium has a magnetic characteristic having a magnetization curve with a slope α of not less than 5 near a coercive force.

2. The medium according to claim 1, wherein the nonmagnetic layer mainly contains one of platinum and palladium.

3. The medium according to claim 1, wherein the oxide is at least one material selected from the group consisting of cobalt oxide, titanium oxide, silicon oxide, tungsten oxide, and tantalum oxide.

4. The medium according to claim 3, wherein the oxide is titanium oxide.

5. The medium according to claim 1, wherein the magnetic crystal grains has an average diameter of 2 nm (inclusive) to 10 nm (inclusive).

6. The medium according to claim 1, wherein the nonmagnetic layer includes nonmagnetic crystal grains and pinning sites made of an oxide dispersed in the entire nonmagnetic layer, the pinning sites in the nonmagnetic layer being connected to the pinning sites in an adjacent magnetic layer and forming a columnar shape.

7. The medium according to claim 1, wherein the underlayer mainly contains ruthenium.

8. The medium according to claim 7, wherein an Ar gas pressure when forming the underlayer is 0.1 to 1.5 Pa.

9. A magnetic recording/reproducing device comprising:
a perpendicular magnetic recording medium; and
a magnetic head including a single-pole recording element,
the perpendicular magnetic recording medium including:
a substrate, and
a multilayered magnetic recording layer including an underlayer provided on the substrate and made of crystal grains in which a width of a grain boundary between the crystal grains is less than 0.5 nm, and at least two magnetic layers and two nonmagnetic layers formed in contact with the underlayer and alternately stacked,
wherein the magnetic layer comprises a magnetically continuous film which is made of magnetic crystal grains mainly containing Co and an oxide dispersed in the entire magnetic layer, includes a plurality of pinning sites capable of pinning a domain wall, and is exchange-coupled in an in-plane direction in the entire magnetic recording layer, and
the perpendicular magnetic recording medium has a magnetic characteristic having a magnetization curve with a slope α of not less than 5 near a coercive force.

10. The device according to claim 9, wherein the nonmagnetic layer mainly contains one of platinum and palladium.

11. The device according to claim 9, wherein the oxide is at least one material selected from the group consisting of cobalt oxide, titanium oxide, and silicon oxide, tungsten oxide, and tantalum oxide.

12. The medium according to claim 11, wherein the oxide is titanium oxide.

13. The device according to claim 9, wherein the magnetic crystal grains has an average diameter of 2 nm (inclusive) to 10 nm (inclusive).

14. The device according to claim 9, wherein the nonmagnetic layer includes nonmagnetic crystal grains and pinning sites made of an oxide dispersed in the entire nonmagnetic layer, the pinning sites in the nonmagnetic layer being connected to the pinning sites in an adjacent magnetic layer and forming a columnar shape.

15. The device according to claim 9, wherein the underlayer mainly contains ruthenium.

16. The medium according to claim 15, wherein an Ar gas pressure when forming the underlayer is 0.1 to 1.5 Pa.
